(19) United States
(12) Patent Application Publication
(10) Pub. No.: US 2010/0306072 A1
(43) Pub. Date: Dec. 2, 2010

(54) INSTANT FINANCIAL CREDIT SYSTEM

(75) Inventors: William Joseph (Jr.) Ford, JR., Wilmington, DE (US); Eric Anthony, West Grove, PA (US); John W. Thomas, Kennett Square, PA (US); Kevin August, Kensington, MD (US); M. Ehsan Kahn, Kennett Square, PA (US); Richard Kochendorfer, Landenberg, PA (US); Roy Woodham, Bear, DE (US); Michael S. Miller, Lincoln University, PA (US); Jesse Cyr, Wilmington, DE (US); Satheesh Kumar Swaminathan, Hockessin, DE (US); Robert Coomes, Landenberg, PA (US); Lincoln Baxter, Charlotte, NC (US); Tapio Makinen, Newark, DE (US); Scott Godsey, Hockessin, DE (US); Thomas Scott Denbow, Wilmington, DE (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/549,990

(22) Filed: Aug. 28, 2009

Related U.S. Application Data
(60) Provisional application No. 61/182,480, filed on May 29, 2009.

(51) Int. Cl. G06Q 40/00

(52) U.S. Cl. 705/21; 705/38

(57) ABSTRACT

Systems, apparatus, and computer program products are provided that allow for a credit partner, such as a retailer, to process a customer credit card application at multiple point-of-sale/point-of-contact channels, such as a manned or self-service cash register, a manned or unmanned kiosk, partner web site, a call center or the like and, if the customer is approved, allow for the customer to transact using the approved credit account at the credit partner location/site. The systems, methods and computer program provide for integration of the credit application system within multiple point-of-sale channels without requiring a large degree of customization and/or configuration at the credit partner level. In addition, embodiments support both active and passive instant credit decision processing.

### CROSS REFERENCE TO RELATED APPLICATIONS

This application claims benefit of priority under 35 U.S.C. §119(e) to the filing date of U.S. Provisional Application No. 61/182,480, as filed on May 29, 2009, which is incorporated herein by reference in its entirety.

### FIELD

In general, embodiments herein disclosed relate to systems, methods, and computer program products for providing instant financial credit to consumers and, more specifically, an off-the-shelf, credit partner solution for providing retail customers instant credit request processing and the immediate ability to conduct transactions with approved credit.

### BACKGROUND

Many retailers offer the consumer the opportunity to apply for instant credit at the point-of-sale, such as just prior to initiating a check-out process. If the consumer is approved and accepts the terms of the credit agreement, the consumer may immediately use the credit to purchase the proposed goods or services. Continuous use of the extended credit is afforded to the consumer in the form of a private label or general-use credit card, which is subsequently mailed to the consumer.

In most instances, the retailer partners with a financial institution, such as a bank or the like, in order to afford the consumer the option of obtaining instant credit. Such a partnership relationship is commonly referred to as an “affinity partnership”. In this regard, the financial institution is the entity that decisions or otherwise approves the consumer for credit and, if successfully approved, extends the credit to the consumer.

As the consumer and retail partner demand for instant credit rapidly grows, retailers desire the ability to allow for credit issuance at any point-of-contact/point-of-sale (POS), such as a cash register, a sales kiosk, an ecommerce website, a call center, etc. However, current systems for providing instant credit require different solutions/systems for different point-of-contact/point-of sale channels. For example, one solution/system may exist and be employed for retail point-of-sale credit offerings, while another solution/system may exist for the e-commerce channel and a still further solution/system may exist for a retail call center channel.

In addition to all of the different channels requiring distinct solutions/systems, in many if not most instances, off-the-shelf solutions do not exist for these channels because of the diverse nature of the hardware and/or software implemented at various different retail partners. For example, the diversity in POS hardware and software amongst different retail partners results in the need to provide customized solutions for each retail partner. These customized solutions are not only slow to market but are also costly in terms of implementation and maintenance. The retail partner and/or financial institution must undertake significant development work to accommodate the compatibility of the retailer's hardware and software to the financial institution's instant credit system. In most instances custom software code must be written, tested and maintained for each different retail partner based on variances in the hardware and/or software they currently implement.

Therefore, a need exists to develop systems, method, computer program products and the like for a comprehensive instant credit system. The desired systems, methods and computer program products should alleviate problems related to individual solutions for individual points-of-contact/points-of-sale. In this regard, the desired solution should support multiple different point-of-contact/point-of-sale channels, such as, but not limited to, retail POS, manned and unmanned kiosks, e-commerce, web enabled devices, such as mobile devices, partner call centers and the like. Web-enabled devices as described and referred to herein are defined as a device having network connectivity and capable of supporting a web browser application. In addition, the desired systems, methods and computer program products should be readily deployable at the retail partner level such that customization and/or configuration are minimal. In this regard, from the retail partner perspective, time to market and costs related to implementation should be minimized. Additionally, from the financial institution perspective, the desired systems, methods and computer program products should be scalable to allow for multiple different retail partners to implement the system at their multiple different points-of-contact and/or points-of-sale. In addition, the desired systems, methods and computer program products should provide for active instant credit decision processing (i.e., when the customer knowingly applies for instant credit) and passive instant credit decision processing (i.e., when the customer is pre-qualified for credit absent their knowledge).

### SUMMARY

The following presents a brief summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, devices, systems and computer program products are described herein that provide for an instant financial credit system that allows for credit partners to process credit applications through a single comprehensive instant credit system regardless of application input channel or type of device. In this regard, the present invention supports the input of credit applications via multiple different points-of-contact/points-of-sale channels, such as, but not limited to, retail POS, manned and unmanned kiosks, e-commerce, partner call centers, web enabled device, such as mobile devices, and the like. As such, the present invention mitigates problems related to individual solutions for individual points-of-contact/points-of-sale. In addition, the systems, methods and computer program products described herein can accommodate different retailer hardware and/or software, thus, eliminating the need to provide elaborate customization and/or configuration at the retail level as a means of providing for instant credit processing. In this regard, the present invention minimizes time-to-market and costs associated with customization. In addition, the presently described systems, methods and computer program products provide for active instant credit decision processing (i.e., when the customer knowingly applies for instant credit), as well as, passive instant credit decision processing (i.e., when the customer is pre-qualified for credit absent their knowledge). Also, the present invention provides for scalability beyond instant credit but may also be used to instantly decision and approve customers for other financial institution services or products, such as specific accounts, debit cards or the like, whether in conjunction with the instant credit decisioning process or as a stand-alone instant decision process.

A system for providing instant credit processing defines one embodiment of the invention. The system includes a protocol adapter in communication with one or more instant credit request first input channels, which are associated with a credit partner. The protocol adapter includes a message transformation routine that is configured to transform credit request messages and credit decision messages communicated from and to the first input channels. The transformation of the messages provides for upstream and downstream communication within the instant credit decisioning system. The system also includes an enterprise gateway in communication with the protocol adapter and configured to provide an interface between the protocol adapter and the credit-issuing entity. Additionally, the system includes a credit-issuing entity, such as a financial institution or the like, in communication with the enterprise gateway and configured to provide a plurality of interfacing services related to an instant credit request including communicating a decision for the instant customer credit decision request.

In optional embodiments the system may also include an instant credit web application in communication with one or more instant credit request second input channels and the enterprise gateway. The second input channels are web-enabled input channels associated with the credit partner. According to specific related embodiments of the system, the instant credit web application is further defined as a credit partner-configurable application operable to provide the credit partner customization based on one or more device types of the second input channels.

According to specific embodiments of the invention the first and second input channels are not mutually exclusive and, as such the first input channels may include one or more of the second input channels and vice versa. According to one embodiment of the system the one or more instant credit request first input channels include one or more of a non web-enabled point-of-sale, a web-enabled point-of-sale, a self-service point-of-contact, such as self-service kiosks, a credit partner-manned point-of-contact, such as manned kiosks, a web-enabled device or a credit partner call center. According to another embodiment of the system the one or more instant credit request second input channels include one or more of a web-enabled point-of-sale, a self-service point-of-contact, a credit partner-manned point-of-contact, a credit partner call center, a web-enabled mobile device, a web-enabled wired device, or an electronic commerce web application.

According to still further specific embodiments of the system, the plurality of interfacing services provided by the credit-issuing entity includes an active credit decisioning service. An “active” credit decisioning service implies that the instant credit decision is determined on-the-fly based on a currently received instant credit request. In another specific embodiment, the plurality of interfacing services provided by the credit-issuing entity includes a passive credit decisioning service. The “passive” credit decisioning service implies credit pre-approval determined based on a previous encounter with the credit partner or the credit-issuing entity.

According to additional embodiments of the system, the plurality of interfacing services provided by the credit-issuing entity includes other financial products decisioning service, wherein the other financial products decisioning is at least one of active other financial product decisioning or passive other financial product decisioning.

In additional embodiments of the system, the protocol adapter and/or the enterprise gateway includes a store-and-forward (SAF) routine configured to process instant credit requests at a later point in time in the event that an upstream capability is presently unavailable. The SAF routine implements a queue whereby requests are communicated based on a first-in, first-out priority scheme.

In additional alternate embodiments of the system, the enterprise gateway includes a reconciliation routine configured to perform out-of-channel credit decision processing in an event instant credit decisioning is presently unavailable.

Another system for providing instant credit processing provides for another embodiment of the invention. The system includes an instant credit web application in communication with one or more instant credit request input channels, which are associated with a credit partner. The instant credit web application is configured to receive credit requests from the input channels, communicate the credit requests to the credit-issuing entity via the enterprise gateway, receive credit decisions from the credit-issuing entity via the enterprise gateway and communicate the credit decision to a respective input channel. The system also includes an enterprise gateway in communication with the instant credit web application. The enterprise gateway is configured to provide an interface between the instant credit web application and the credit-issuing entity. Additionally, the system includes a credit-issuing entity in communication with the enterprise gateway. The credit-issuing entity is configured to provide a plurality of interfacing services related to an instant credit request including communicating a decision for the instant customer credit decision request.

In one specific embodiment of the system, the instant credit web application is further defined as a credit partner-configurable application operable to provide the credit partner customization based on one or more device types of the input channels.

In other specific embodiments of the system, the one or more instant credit request input channels include one or more of a point-of-sale, a self-service point-of-contact, a credit partner-manned point-of-contact, a credit partner call center, a web-enabled mobile device, a web-enabled wired device, or an electronic commerce web application.

In still further additional embodiments of the system, the enterprise gateway further includes a reconciliation routine configured to perform out-of-channel credit decision processing in an event instant credit decisioning is presently unavailable.

In still another embodiment of the system, the plurality of interfacing services provided by the credit-issuing entity include two or more of active credit decisioning service, passive credit decisioning service, other financial product decisioning service, customer identification and authentication service, offers management service, product marketing data service, product agreement disclosure service and application disclosure service. In those embodiments in which the plurality of interfacing services provided by the credit-issuing entity includes an active credit decisioning service, the instant credit decision may be determined based on a currently received instant credit request. In those embodiments in which the plurality of interfacing services provided by the credit-issuing entity includes a passive credit decisioning service, the instant credit decision may be credit pre-approval determined based on a previous encounter with the credit partner or the credit-issuing entity. Additionally, in those embodiments in which the plurality of interfacing services provided by the credit-issuing entity includes other financial products decisioning service, the other financial products decisioning is at least one of active other financial product decisioning or passive other financial product decisioning.

Yet another system for providing instant credit processing defines another embodiment of the invention. The system includes a protocol adapter in communication with one or more instant credit request first input channels, which are associated with a credit partner. The system additionally includes an instant credit web application in communication with one or more instant credit request second input channels, which are associated with the credit partner. Additionally, the system includes an enterprise gateway in communication with the protocol adapter and the instant credit web application, and a credit-issuing entity in communication with the enterprise gateway. The protocol adapter includes a message transformation routine configured to transform credit request messages and credit decision messages communicated from and to the first input channels to provide for upstream and downstream communication within the instant credit decisioning system. The instant credit web application is configured to receive instant credit requests from the second input channels, communicate the credit requests to the credit-issuing entity via the enterprise gateway, receive credit decisions from the credit-issuing entity via the enterprise gateway and communicate the credit decision to a respective input channel. The enterprise gateway is configured to provide an interface between the protocol adapter and the credit-issuing entity and the credit-issuing entity is configured to provide a plurality of interfacing services related to an instant credit request including communicating a decision for the instant customer credit decision request.

In specific embodiments of the system the one or more instant credit request first input channels include one or more of a non web-enabled point-of-sale, a web-enabled point-of-sale, a self-service point-of-contact, a credit partner-manned point-of-contact, a web-enabled device or a credit partner call center. While in other embodiments of the system, the one or more instant credit request second input channels include one or more of the web-enabled point-of-sale, the self-service point-of-contact, the credit partner-manned point-of-contact, the credit partner call center, the web-enabled wired device, a web-enabled mobile device, or an electronic commerce web application.

In other embodiments of the system, the plurality of interfacing services provided by the credit-issuing entity includes an active credit decisioning service, in which the instant credit decision is determined based on a currently received instant credit request. In other embodiments of the system, the plurality of interfacing services provided by the credit-issuing entity includes a passive credit decisioning service, in which the instant credit decision is credit pre-approval determined based on a previous encounter with the credit partner or the credit-issuing entity. In still further embodiments of the system, the plurality of interfacing services provided by the credit-issuing entity includes other financial products decisioning service, in which the other financial products decisioning is at least one of active other financial product decisioning or passive other financial product decisioning.

A protocol adapter apparatus configured to process instant credit requests provides for another embodiment of the invention. The apparatus includes a first transceiver configured to receive instant credit request messages from one or more point-of-sale (POS) devices and transmit instant credit decision messages. Additionally the apparatus includes a protocol transformer configured to transform one or more instant credit requests messages from a POS device format to a predetermined instant credit format and transform corresponding instant credit decision messages from the predetermined instant credit format to the POS device format. The apparatus also includes a second transceiver configured to transmit transformed instant credit request messages to an enterprise gateway and receive instant credit decision messages in the predetermined format from the enterprise gateway.

In one such embodiment of the apparatus, the protocol transformer is further configured to transform the instant credit requests from a POS device to Extensible Markup Language (XML) format.

In other embodiments of the apparatus, the first transceiver further includes a persistent network listener configured to continuously listen to the one or more POS devices. In further related embodiments, the first transceiver is further configured to receive instant credit requests from one or more of a point-of-contact (POC), a credit partner call center or a web-enabled device.

In still further embodiments of the apparatus, the second transceiver further includes a Transmission Control Protocol (TCP) socket. In other related embodiments, the second transceiver is further configured to transmit and receive via Secure Socket Layer (SSL) protocol and Java Message Service (JMS) protocol.

Another embodiment of the apparatus includes a Store-And-Forward (SAF) queue and message broker configured to queue instant credit requests in the event a timeout. In other embodiments the apparatus includes a heartbeat monitor configured to ensure a channel is maintained between the enterprise gateway and a credit-issuing entity and/or the protocol adapter and the enterprise gateway.

A computer program product including a computer-readable medium defines another embodiment of the invention. The medium includes a first set of codes for causing a computer to receive first instant credit request messages from Point-Of-Sale (POS) devices, such as non web-enabled POS devices and the like. The medium additionally includes a second set of codes for causing a computer to transform the first instant credit request messages from a POS device type-specific format to a predetermined network-compatible format. Additionally, the medium includes a third set of codes for causing a computer to transmit the transformed first instant credit request messages to a credit-issuing entity.

In alternate embodiments of the computer program product, the first set of codes is further configured to cause the computer to receive second instant credit messages from Point-Of-Contact (POC) devices, such as non web-enabled POC devices and/or a credit partner call center. In such embodiments, the second set of codes is further configured to cause the computer to transform the second instant credit messages from a POC device type-specific or a call center-specific format to the predetermined network-compatible format.

In another alternate embodiment, the medium of the computer program product includes a fourth set of codes for causing the computer to receive an instant credit decision messages from the credit-issuing entity, a fifth set of codes for causing a computer to transform the instant credit decision messages from the predetermined network format to the POS device-type specific format, and a sixth set of codes from causing a computer to transmit the transformed instant credit decision messages to a POS device associated with the corresponding instant credit request message.

In a further embodiment the medium of the computer program product includes a fourth set of codes for causing a computer to store the transformed first instant credit request messages in a queue based on an occurrence of a timeout. In yet another embodiment of the computer program product the medium includes a fourth set of codes for causing a computer to monitor activeness of a connection to a gateway device. In such embodiments, the medium of the computer program product may also include a fifth set of codes for causing a computer to generate an alert message in an event that the connection to the gateway device is determined to be inactive.

Thus, present embodiments, which are described in more detail infra. provide for a comprehensive instant financial credit system that allows for a retail credit partner to offer and process instant credit requests at most Points-Of-Sale (POS) or Points-Of-Contact (POC). In addition, the embodiments described herein provide for an off-the-shelf instant credit system that can be implemented at most credit partners without the need for elaborate customization or configuration, as required by current point-to-point instant credit solutions and/or systems. Thus, the disclosed embodiments vastly improve the deployment time encountered by current systems which require custom software, configuration and the like. In addition, present embodiments support both “active” instant credit decisioning and “passive” instant credit decisioning. Active decisioning allows for credit decisions to be made on-the-fly based on information provided for in the instant credit request and passive decisioning provides for pre-approved credit based on information previously provided to the credit-issuing entity and/or credit partner. In addition, embodiments herein disclosed provide for safeguards in the event that instant credit decisions are currently unavailable, such as subsequent reconciliation processing and notification of credit approval.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a high-level block diagram of an instant financial credit system, in accordance with an embodiment of the present invention;

FIG. 2 is another high-level block diagram of an instant financial credit system, in accordance with an alternate embodiment of the present invention;

FIG. 3 is another high-level block diagram of an instant financial credit system, in accordance with an alternate embodiment of the present invention;

FIG. 4 is a block diagram of a system for providing instant financial credit, in accordance with one embodiment of the present invention;

FIG. 5 is a block diagram of a system for providing instant financial credit highlighting the ability of the system to accommodate multiple different instant credit request input channels, in accordance with an embodiment of the present invention.

FIG. 6 is a block diagram of a system for providing instant financial credit via credit partners highlighting exemplary communication protocols mechanisms, in accordance with one embodiment of the present invention;

FIG. 7 is a block diagram of a system for instant credit highlighting an implementation that includes a protocol adapter, in accordance with an embodiment of the present invention;

FIG. 8 is a sequence diagram for active instant credit processing at a retail point-of-sale/cash register, in accordance with an embodiment of the present invention;

FIG. 9 is a sequence diagram for active instant credit processing at a manned kiosk, in accordance with an embodiment of the present invention;

FIG. 10 is a sequence diagram for a customer purchase using the extended instant credit on a return visit to the retail location prior to receipt of a permanent credit card, in accordance with an embodiment of the invention

FIG. 11 is a sequence diagram for active instant credit processing at a partner website, in accordance with an embodiment of the present invention; and

FIG. 12 is a sequence diagram for active instant credit processing at a partner call center, in accordance with an embodiment of the present invention;

FIG. 13 is a sequence diagram for passive instant credit processing at a retail point-of-sale/cash register, in accordance with an embodiment of the present invention; and

FIG. 14 is a sequence diagram for passive instant credit processing at a manned kiosk, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems or apparatus that may include a number of devices, components, modules, and the like. It is to be understood and appreciated that the various systems or apparatus may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

Thus, methods, devices, systems and computer program products are described herein that provide for instant decisioning and/or issuance of financial credit by credit partners, such as affinity partners or the like, associated with credit-issuing entities. In accordance with certain embodiments of the invention, the instant credit system allows for credit partners to process credit applications regardless of the input channel. In this regard, the present invention supports the input of such applications via multiple different points-of-sale (POS)/points-of-contact (POC) channels, such as, but not limited to, web-enabled POSs, non web-enabled POSs, manned and unmanned kiosks, e-commerce, web enabled devices, such as mobile devices, partner call centers and the like. As previously noted, web-enabled devices, as described herein are defined as devices having network connectivity and capable of supporting a web browser application. As such, the present invention mitigates problems related to individual solutions for each credit partner and for individual points-of-contact/points-of-sale within a credit partner's environment. Thus, the systems, methods and computer program products described herein can accommodate different retailer hardware and/or software, thus, eliminating the need to provide elaborate customization and/or configuration at the retail level as a means of providing for instant credit processing. In this regard, the present invention minimizes time-to-market and costs associated with customization.

In addition, the presently described systems, methods and computer program products provide for active instant credit decision processing (i.e., when the customer knowingly applies for instant credit) or the like, as well as, passive instant credit decision processing (i.e., when the customer is pre-qualified for credit absent their knowledge) or the like.

Additionally, the present invention may also be used to instantly decision and issue customers other financial institution services or products, such as specific checking accounts, savings accounts or other accounts, debit cards or the like, whether in conjunction with the instant credit decisioning process or as a stand-alone instant decision process.

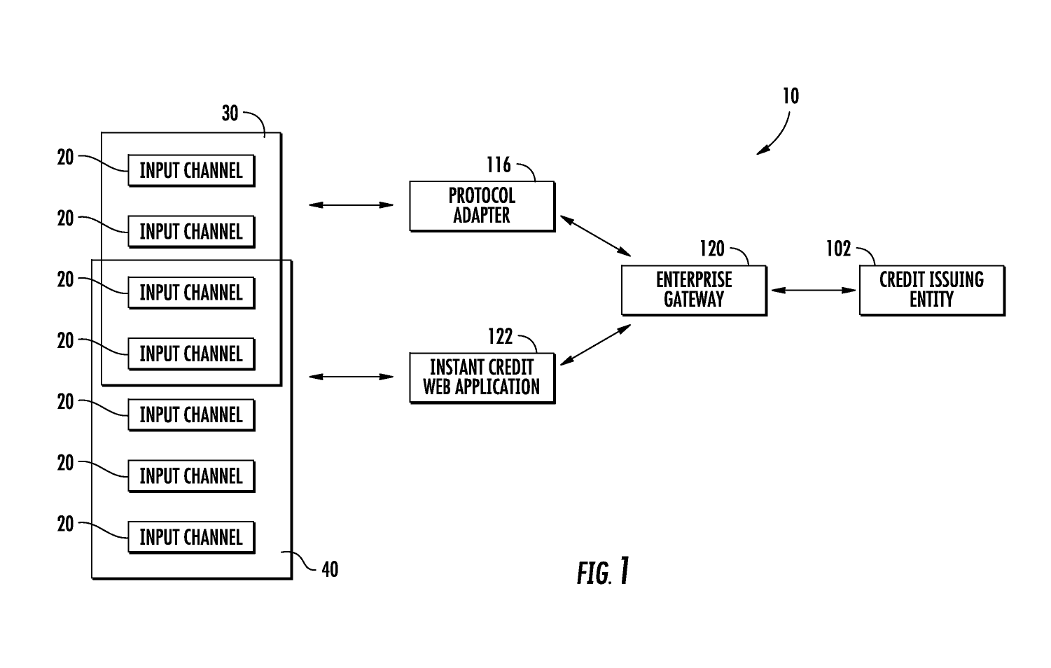

Referring to FIG. 1, a high-level block diagram is depicted of an instant credit system, in accordance with an embodiment of the present invention. The system includes a plurality of input channels 20 that generate instant credit requests and are associated with a credit partner. The input channels 20 are in communication with at least one of a protocol adapter 116 and an instant credit web application 122. The protocol adapter 116 and the instant credit web application 122 are in communication with an enterprise gateway 120. The enterprise gateway 120 is in communication with the credit issuing entity 102, such as a financial institution, which decisions the instant credit requests and communicates the decisions downstream to the input channels through the enterprise gateway 120, the instant credit web application 122 and the protocol adapter 116.

By way of example, the input channels 20 may include POS terminals/devices, such as web-enabled/smart cash registers, non web-enabled/traditional cash registers and the like, POC terminals/devices, such as manned or unmanned kiosks or the like, call centers, e-commerce sites, mobile devices and the like. As depicted, a first set 30 of the input channels 20 are in communication with a protocol adapter 116 and a second set 40 of the input channels are in communication with an instant credit web application 122. As shown, input channels 20 in the first set 30 are not required to be mutually exclusive from the input channels 20 in the second set 40. This means that a certain input channel type, for example web-enabled/smart POS devices may be configured by a credit partner to be in communication with either the protocol adapter 116 or the instant credit web application 122.

By definition as a “web” application the instant credit web application 122 is accessible to any web-enabled device. Thus, input channels 20 included within the second set 40 are characterized as being web-enabled devices. The instant credit web application 122 is further configured to receive instant credit requests from the second set 40 of input channels 20, communicate the credit requests to the credit-issuing entity 102 via the enterprise gateway 120, receive credit decisions from the credit-issuing entity 102 via the enterprise gateway 120 and communicate the credit decision to the corresponding input channel 20. Thus, the instant credit web application 122 is a universal application that is accessible to all credit partners. In addition, the instant credit web application 122 is configurable to be customized to meet partner-specific needs and/or accommodate partner-specific input channels (i.e., unique or partner-specific web-enabled devices).

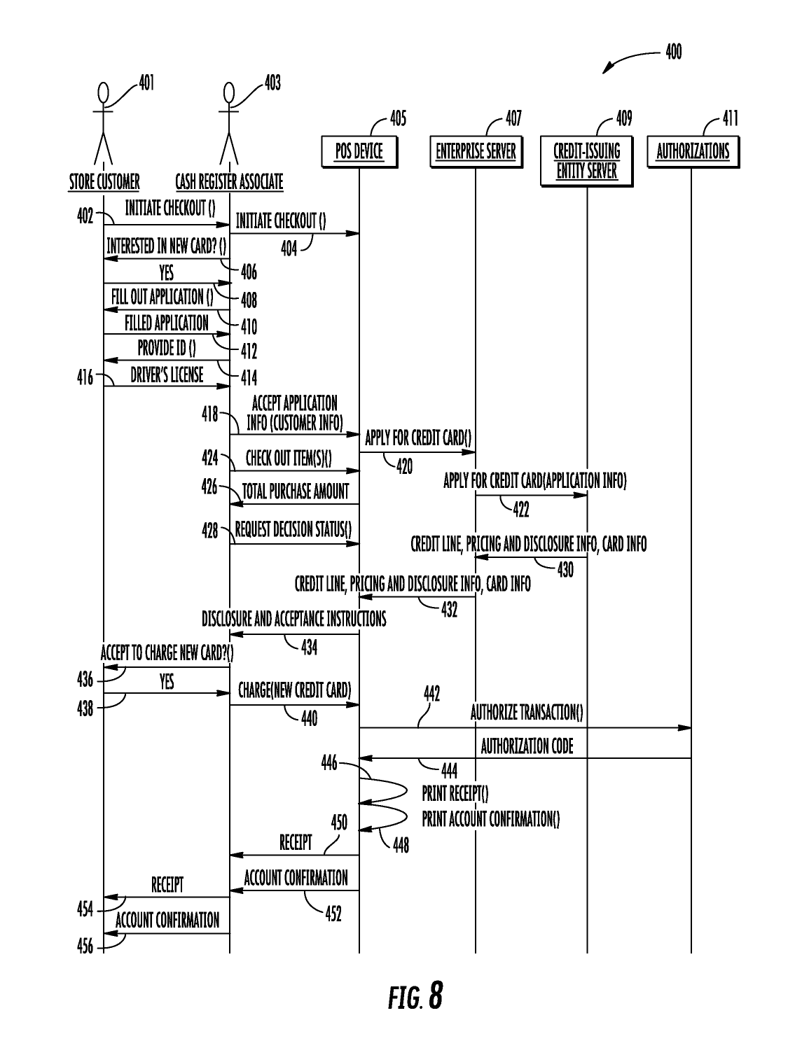

The protocol adapter 116 includes a message transformation routine configured to transform credit request messages and credit decision messages communicated from and to the input channels to provide for upstream and downstream communication within the instant credit decisioning system. Thus, while the protocol adapter 116 is accessible to both web-enabled input channels and non web enabled input channels, the protocol adapter 116 is especially suited to accommodate non web-enabled input channels, such as traditional cash registers or the like, that require message transformation/adaption in order to communicate downstream with the credit-issuing entity 102. Further details of the protocol adapter are discussed in relation to FIG. 7, infra.

The enterprise gateway 120 provides an interface between the protocol adapter 116, the instant credit web application 122 and the credit-issuing entity 102. In certain embodiments, in addition to controlling the processing of instant credit requests, the enterprise gateway 120 provides a reconciliation function in which the enterprise gateway is able to complete the processing of credit requests that are unable to be completed within a specified period of time. In most instances in which instant credit requests are being conducted during a retail check-out process the amount of time allotted to an instant credit request is minimal to ensure that the checkout process is not delayed a significant amount by the credit request. If a given instant credit request fails to complete during the allotted time, due to processing errors, unavailability of the credit-issuing entity processing capability or the like, the reconciliation function provides for the credit processing to proceed at a later time and for the customer to be notified of the outcome of the decision process at a later time, typically via telephone call or mailing.

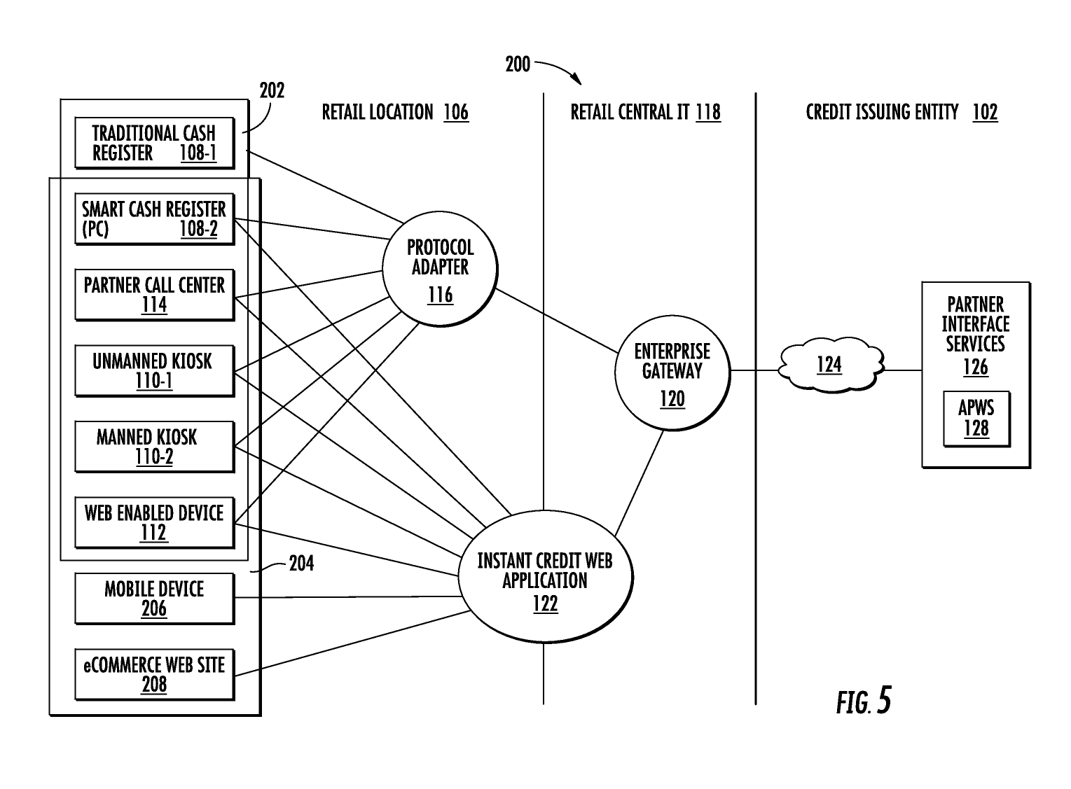

The credit issuing-entity 102 is configured to provide a plurality of interfacing services related to an instant credit request including communicating a decision for the instant customer credit request. As discussed in detail in relation to FIG. 4, according to certain embodiments of the invention, decisioning of the instant customer credit request may include a real-time “active” decision that is based on information in the instant credit request/application or a “passive” decision that is a pre-approval based on prior information provided to the credit partner and/or the credit-issuing entity.

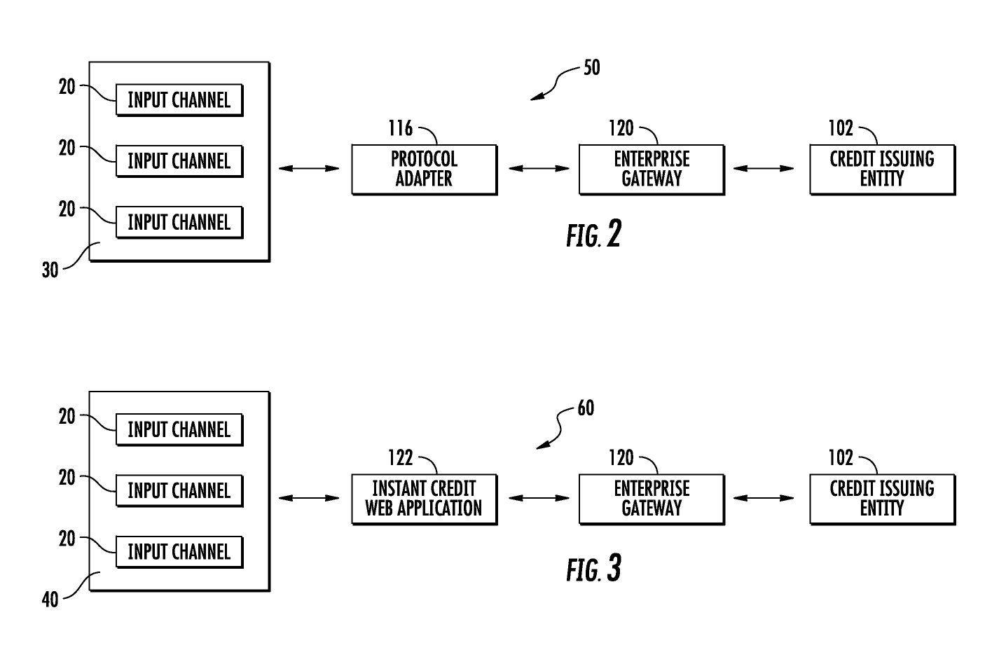

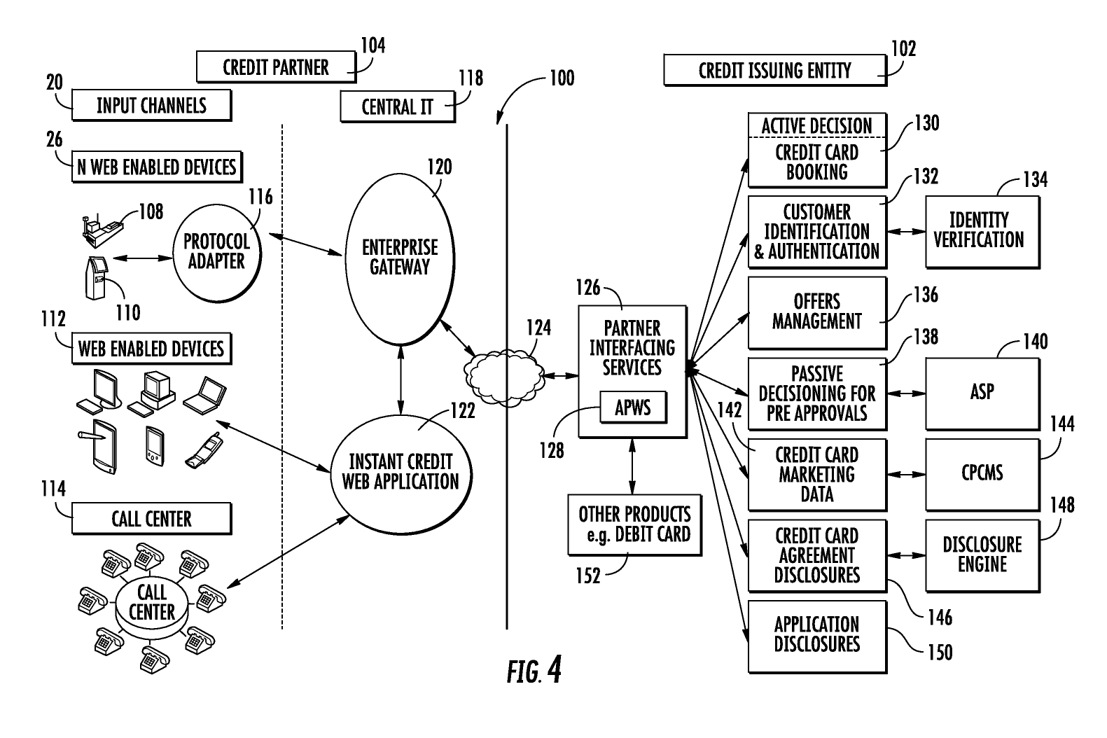

FIGS. 2 and 3 illustrate alternate embodiments of the present invention. Specifically, FIG. 2 depicts an instant credit system 50 that includes a first set 30 of input channels 20 in communication with a protocol adapter 116, an enterprise gateway 120 and the credit-issuing entity 102. The instant credit system 50 of FIG. 2 may be configured for a credit provider that is limited to having only non web-enabled input channels, such as traditional cash registers or the like. FIG. 3 depicts an instant credit system 60 that includes a second set 40 of input channels 40 in communication with a an instant credit web application 122, an enterprise gateway 120 and the credit-issuing entity 102. The instant credit system 60 of FIG. 3 may be configured for a credit provider that has only web-enabled input channels (i.e., the credit partner does not have any non web-enabled input channels, such as traditional cash registers or the like).

FIG. 4 is a block diagram representation of a system 100 for providing instant credit application processing in accordance with an embodiment of the present invention. The credit partner 104, which may be a retailer or the like may provide for multiple different input channels 105 for inputting customer instant credit requests or the like. The input channels 105 may include non-web enabled devices 106, such as traditional POS devices 108, non web-enabled POC devices 110 or the like. The traditional POS devices 108 and the non web-enabled POC devices 110 may be manned devices, i.e., devices operated by a retail associate or the POS devices 108 and the POC devices 110 may be unmanned, self-service devices operated by the customer. Traditional POS devices 108 and POC devices 110 are generally considered to be “conventional” or “legacy” devices, which are defined as devices that have network capability but are not web-enabled devices.

Additionally, input channels 105 may include web-enabled devices 112, such as web-enabled POS devices, web-enabled POC devices, such as, but not limited to, personal computers, kiosks and the like, and mobile devices, such as laptop computers, cellular telephones, personal data assistants, tablet devices and the like. The web-enabled devices may be credit partner-manned devices, which provide for retail associates to enter the data required for the instant credit applications or unmanned devices, which require the customer to enter the data required for the instant credit application.

In addition, credit partner call center 114 provides for another example of an input channel for inputting customer instant credit applications. In this regard, call center 114 is a collection of telephone operators associated with the financial institution partner, such as a retailer or the like, which take product/service orders, and/or answer product/service questions or the like. In accordance with present embodiments, the call center operators may also offer instant credit processing. In accordance with present embodiments, the system of the present invention allows for the illustrated input channels, as well as other conceivable input channels, to connect with the credit-issuing entity 102, for the purpose of determining and, if approved, issuing instant credit to a customer requesting such.

The instant credit processing system 100 of the present invention additionally includes a protocol adapter 116 that is in communication with the non web-enabled devices/input channels 106 1, such as traditional POS devices 108 and non web-enabled POC devices 110. In certain embodiments, the protocol adapter 116 may be executed on a controller or the like (not shown in FIG. 4) that is in communication with the traditional POS devices 108 and/or POC devices 110 and may be located within the retail location. In other embodiments the protocol adapter 116 may reside within a central Information Technology (IT) hub 118 of the credit-issuing entity.

The protocol adapter 116 is an interface that is configured to provide for the POS devices 108 and/or the POC devices 110 to communicate with the enterprise gateway 120 and the instant credit infrastructure of the credit-issuing entity 102. In this regard, the protocol adapter 116 may be configured to transform and/or reconfigure data communicated from the POS devices 108 and/or the POC devices 110 for the purpose of providing upstream communication with the enterprise gateway 120 and the credit-issuing entity 102 and subsequent downstream communication to the POS devices 108 and POC devices 110. By providing for the ability to connect multiple different traditional POS device types and/or non web-enabled POC devices to the enterprise gateway 120, the protocol adapter 116 significantly reduces the effort required to customize the instant credit process based on the specific type of POS device and/or POC device. Additionally, in some embodiments, the protocol adapter 116 and/or the enterprise gateway is configured to provide “Store And Forward” (SAF) support in the event that a communication breakdown between the protocol adapter 116 and the enterprise gateway 120 or another error occurs that prevents transmission of the instant credit request, in which case, the SAF capability allows for subsequent attempts at transmission of the instant credit request.

The web-enabled devices 112 and the call center 114 are in communication with an instant credit web-based application 122. In addition to providing an interface between the web-enabled devices 112/call center 114 and the enterprise gateway 120, the web application is easily configurable to meet the needs and customization requirements of each individual credit partner. According to one embodiment, the instant credit web application 122 is executed at a server residing at a central Information Technology (IT) hub 118 or headquarters for the credit partner retailer 104.

The protocol adapter 116 and the instant web credit application are in communication with the enterprise gateway 120. The enterprise gateway 120 serves as the communication bridge between the different input channels, such as POS device 108, point-of-contact devices 110, web devices 112, call center 114 and the like, and the credit-issuing entity 102, such as a financial institution or the like. In addition, according to specific embodiment, the enterprise gateway 120 provides reconciliation functionality in the event that an instant credit application process fails due to a break in technology or communication between the credit-issuing entity 102, the protocol adapter 116 and/or the instant credit web application 122. The reconciliation function provides for subsequent credit application processing once the errors have been resolved or the system is otherwise functioning properly to allow for credit decision processing. While subsequent credit request processing is typically not an “instant” decision, it does allow for the consumer to receive credit at a later point in time.

The enterprise gateway 120 is in network 124 communication, such as the Internet, an intranet or the like, with the credit-issuing entity 102, and, more specifically, partner interfacing services 126. Partner interfacing services 126 provides an interface for the credit partners 104 and orchestrates and integrates all the functionalities of the credit-issuing entity. In this regard, partner interfacing services 126 provides the capability for each of the credit partners to assess and obtain all of the functions provided for by the credit-issuing entity. Included within the partner interfacing services 126 is the affinity partner web services 128, which include a collection of message service utilities, such as hypertext transfer protocol (http), extensible markup language (xml) and the like, that allow the credit-issuing entity 102 to communicate with the enterprise gateway 120.

The partner interfacing services 126 may include, but are not limited to, active decision credit card booking service 130, customer identification and authentication service 132, offers management service 136, passive decisioning for pre-approvals service 138, credit card marketing data service 142, credit card agreement disclosure service 146 and application disclosure service 150. Active decision credit card booking service 130 is operable to determine whether an applicant can be approved for instant credit based on information received in the instant credit request/application. The customer identification and authentication service 132 is operable to verify the identity of the applicant. In this regard, the customer identification and authentication service 132 may be in communication with an identity verification entity 134, such as a credit bureau or the like, for the purpose of obtaining authentication questions and verifying identity based on applicant submitted answers to the authentication questions.

The offers management service 136 is operable to manage the credit offers provided to an applicant customer to ensure the consistency of offers and to lessen the likelihood of offer redundancy. The passive decisioning service 138 provides for pre-approval credit decisioning processing based on prior identity of the customers being provided to the credit-issuing entity either through the credit partner or through another entity. For example, the customer may be a previous credit partner customer and/or may be a member of the credit partner's loyalty program or the like. In such instances, once a customer is pre-approved, the pre-approved instant credit offer may be presented to the customer and upon confirming the identity of the customer, the credit may be offered and, if accepted, activated. The passive decisioning service 138 may be in communication with an external provider of credit worthiness determination such as application services provider (ASP) 140.

Credit card marketing data service 142 provides for the core data for assembling the credit card offers that may be offered to a partner's customer. The credit card marketing data may include the products offered, the price/terms of the products and the like. The credit card marketing data service 142 may be in communication with a card product content management system to provide for making changes to content, card images, logos, and design implementations of the physical card products.

The credit card agreement disclosure service 146 is operable to determine applicable disclosure requirements and provide for making sure that the disclosures are communicated to the card applicant. In this regard, the credit card agreement disclosure service 146 may be in communication with a disclosure engine 148 for the purpose of determining disclosure requirements and assembling materials to be disclosed to the applicant. The application disclosure service 150 is operable to determine and assemble application disclosures when active credit offerings are being made to an applicant.

In addition, the partner interfacing services 126 may include the ability of offer other products or services 152, such as debit cards or other non-credit products at the time of the instant credit offer, at the time of the credit approval or subsequent to the instant credit process. The other product or service offer(s) provided to a customer may be based on an active decision; i.e., determined in real-time based on information provided in the instant credit request, or the offer(s) may be based on a passive decision i.e., predetermined offers determined based on previous information provided to the credit-issuing entity.

FIG. 5 provides a block diagram representation of a system 200 for providing instant credit processing at different retail partner input channels, according to an embodiment of the present invention. Specifically, FIG. 5 highlights the different enterprise gateway 120 interface that may be afforded to different input channels, specifically, which input channels may interface via the protocol adapter 116 and which input channels may interface via the instant credit web application 122. A first set of input channels 202 may be configured to interface with the enterprise gateway 120 via the protocol adapter 116. The first set of input channels 202 may include, but is not necessarily limited to, traditional POS devices/cash registers 108-1, smart POS devices (e.g., PCs) 108-2, partner call centers 114, unmanned/self-service points-of-contact/kiosks 110-1, manned points-of-contact/kiosks 110-2 and web-enabled devices 112. For those input channels 202 that are non web-enabled devices, such as traditional POS devices/cash registers 108-1 and the like, the protocol adapter 116 is configured to translate the instant credit request message being communicated from such a device to a system specific message format, such as XML format or the like. For those input channels 202 that are web-enabled devices, such as smart POS devices 108-2, web-enabled devices 112 or the like, the instant credit request messages may already be in the desired format, such as XML or the like, obviating the need to perform a translation function. In such instances, in which translation is not required, the protocol adapter 116 may be configured to provide for a mapping of fields to a specified protocol. Thus, the protocol adapter 116 bridges the gap between specialized, POS devices, point-of-contact device, partner applications and the credit-issuing entity. As such, the protocol adapter allows the credit partner to control interaction with the customer.

A second set of input channels 204 may interface with the enterprise gateway 120 via the instant credit web application 122. The second set of input channels 204 may include, but is not necessarily limited to, smart POS devices (e.g., PCs) 108-2, partner call centers 114, unmanned/self-service points-of-contact/kiosks 110-1, manned points-of-contact/kiosks 110-2, web enabled devices 112 and mobile devices 206 and ecommerce web applications 208. The instant credit web application 122 is a universally accessible application for instant credit that can be customized and/or configured to meet partner-specific needs for web-enabled devices.

It should be noted that while FIG. 5 shows certain input channels, such as smart POS/cash registers 108-2, credit partner call center 114, unmanned kiosk 110-1, manned kiosk 110-2 and web-enabled device 112 in communication with both the protocol adapter 116 and the instant web credit application, in practice, the credit partner may configure their input channels to communicate with one or both of the protocol adapter 116 and the instant web credit application 122. In one embodiment, the credit partner 104 may configure all web-enabled devices to communicate with the credit-issuing entity via the instant credit web application 122 and for all non web-enabled devices to communicate with the protocol adapter 116. Thus, if the credit partner does not currently implement any non web-enabled devices, input channel communication with the credit-issuing entity may be limited to the instant credit web application 122. In other embodiments, in which the credit partner configures web-enabled input channels such that they are in communication with the protocol adapter 116 and the web application 122, the web application 122 may be designated as the primary interface and the protocol adapter 116 the secondary or back-up interface, which is implemented in the event that the web application 122 is unavailable.

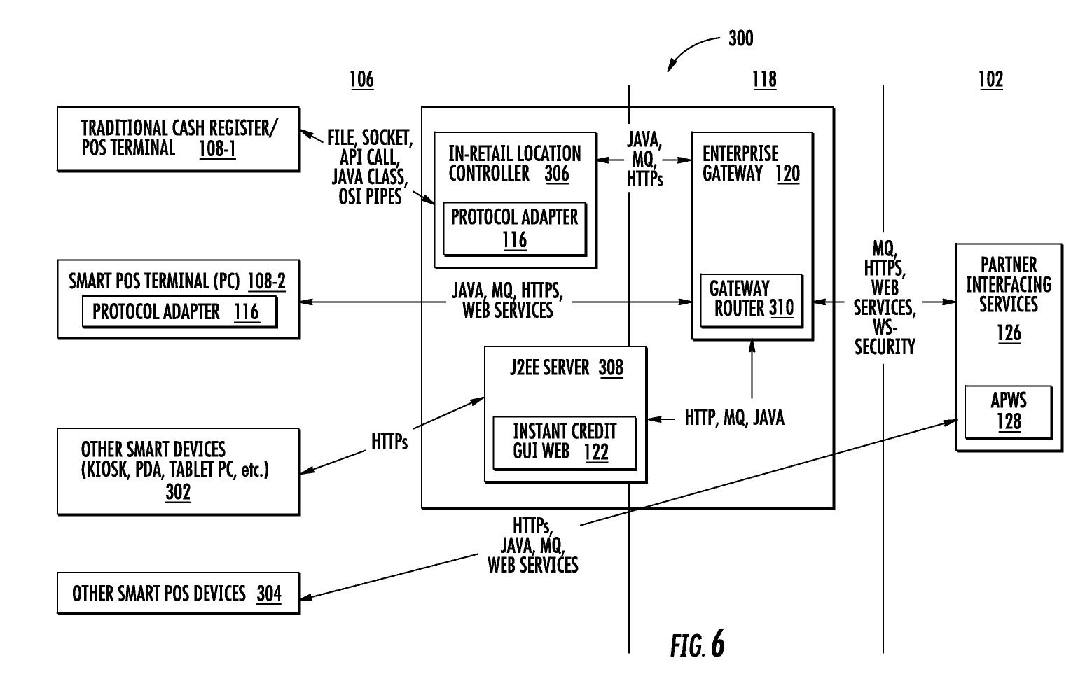

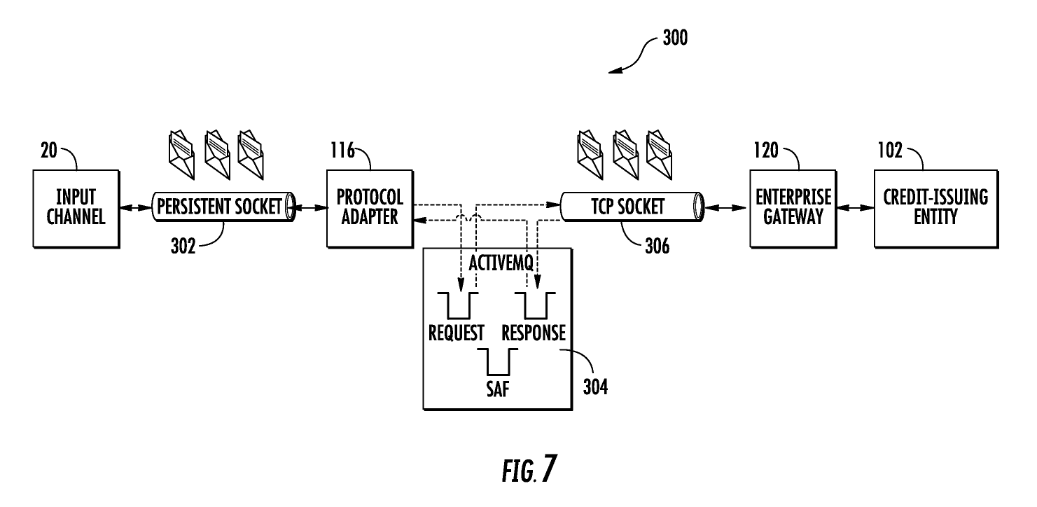

Referring to FIG. 6, another block diagram is depicted of a system 300 for providing instant credit processing at different retail partner input channels, according to an embodiment of the present invention. Specifically, FIG. 6 highlights the various communication mechanisms and protocols that may be implemented in the system. Traditional point-of-sale terminal 108-1, e.g., non web-enabled cash registers may implement file, socket, Application Programming Interface (API) call, Java class and or Open-Systems Interconnection (OSI) pipes to communicate with the protocol adapter 166, which, in the illustrated example of FIG. 6, is executed within an in-retail location controller 306. The in-retail location controller 306 may communicate with the enterprise gateway 120 via Java, Message Queue (MQ), HTTP and/or the like.

In certain embodiments, smart POS terminals 108-2, e.g., web-enabled cash registers may execute the protocol adapter 116 internally and communicate directly with the enterprise gateway 120 via Java, Message Queue (MQ), HyperText Transfer Protocol (HTTP) and/or web services.

In other embodiments, other smart devices 302, such as smart POS terminals, kiosks, PDAs, tablet PCs or the like may communicate with the instant credit GUI web application 122 implemented on a Java 2 platform Enterprise Edition (J2EE) server 308 or the like via HTTP or the like. The server 308 may reside at the retail location or at a central retail location IT hub. The J2EE server 308 may communicate with the enterprise gateway via HTTP. MQ, Java and/or the like.

Additionally, other smart POS devices 304, such as mobile devices or the like, may directly communicate with the credit-issuing entity 102 and, specifically the partner interfacing services 126 via HTTP. Java, MQ, web services or the like. In those embodiments in which smart POS devices 304 are in direct communication with the credit-issuing entity 102, the smart point-of-sale devices 304 may be configured with instant credit GUI web application and the other functionality of the J2EE server 308 and the enterprise gateway 120.

The enterprise gateway 120 and the gateway router 310 included within the enterprise gateway 120 may communicate with the partner interfacing services via MQ, HTTP, web services and may implement web-services (WS) security.

FIG. 7 is a block diagram of an instant credit system 300 highlighting details of the protocol adapter 116, in accordance with an embodiment of the present invention. In certain embodiments of the invention, protocol adapter 116 serves as the connection point between multiple input channels 20 and the enterprise gateway 120. Accordingly, the protocol adapter 116 is in communication with input channels 20 via a persistent socket 302 that is shareable across multiple input sockets. In one embodiment, the persistent socket supports TCP/IP communication or the like. The persistent nature of socket 302 means that protocol adapter 116 continuously listens for messages communicated from the input channels.

The protocol adapter 116 includes a transformation routine 308 that is configured to transform input channel-type specific formatted instant credit request messages to a format conducive to upstream decision processing. In one embodiment, the transformation routine 308 is configured to transform the instant credit request messages to standard Extension Markup Language (XML) format. In those embodiments in which code translation are required, the protocol adapter may include a lookup property file or the like for processing such translations. In addition to transforming request messages, the transformation routine is configured to transform the instant credit decision messages communicated from the credit-issuing entity 102 back to the input channel-type specific format.

The protocol adapter 116 is in communication with a message broker 304, such as an open source message broker, for example ActiveMQ, available from the Apache Software Foundation. The ActiveMQ message broker fully implements Java Message Service (JMS). The message broker 304 includes Store and Forward (SAF) functionality that provides for messages to be placed in a queue for subsequent delivery in the event that the protocol adapter is unable to communicate with the enterprise server 120 over TCP socket 306. The SAF function provides for messages in its queue to be sent to the Enterprise Gateway 120, in First in First out (FIFO) ordering, at predetermined intervals. If the SAF function is unable to send messages in the queue at the prescribed interval, the broker will go back to sleep, wait for the next interval and attempt to send the messages at that time. The interval for sending messages is configurable at the discretion of the credit partner implementing the protocol adapter. In addition message broker 304 is configurable to queue decision messages communicated from the credit-issuing entity 102 in the event that the protocol adapter is unable to communicate with the input channel upon receipt of the instant credit decision message.

Additionally, in certain embodiments, the protocol adapter 116 includes a heartbeat monitor 310 that is configured to ensure that the connection between the enterprise gateway 120 and the credit-issuing entity 102 and/or the connection between the protocol adapter 116 and the enterprise gateway 120 is alive. If the channel is quiet (i.e., not active) and the heartbeat monitor 310 does not receive a heartbeat message from the enterprise gateway 120 within a predetermined interval, an alert message may be configured to be generated and sent to an appropriate alert entity. The alert message may be an XML message placed on a JMS alert queue and sent to a credit partner designated entity.

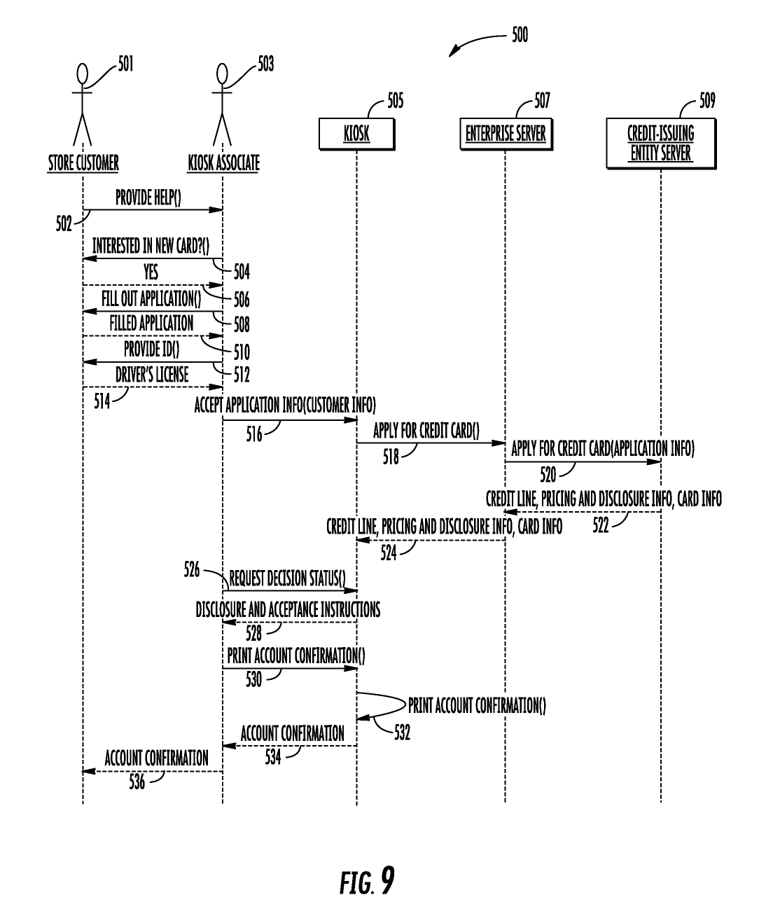

Referring to FIG. 8, a sequence diagram is depicted for active flow instant credit processing 400 at a retail location point-of-sale, such as a cash register, in accordance with an embodiment of the present invention. At Event 402, the customer 401 initiates product or service checkout with a point-of-sale (POS) associate 403 otherwise referred to as a cash register associate. It should be noted that in certain embodiments the need for a cash register associate may be obviated by the implementation of a self-service point-of-sale (POS), otherwise referred to as a self-service cash register. In such embodiments in which the customer chooses to check-out via a self service (POS), a retail associate may be called upon if the customer chooses to apply for instant credit.

At Event 404, the checkout process is initiated by the POS associate 403 interfacing with the POS device 405, such as cash register or the like. The POS associate 403 may scan UPC barcodes associated with the products, enter UPC codes/number or, in instances in which UPC codes are not applicable, enter a corresponding price for product/service. Proximate the initiation of the check-out process, at Event 406, the customer 401 is offered to apply for instant credit. In the illustrated embodiment of FIG. 8, the offer is a verbal offer provided by the POS associate 403, while in other embodiments the offer may be a visual offer presented via a display, such as POS touch screen display or the like. At Event 408, the customer accepts the offer to apply for instant credit, i.e., a credit card. It should be noted that the credit card being offered may be a private label card, which is limited to credit with this particular retailer or the credit card being offered may be a general purpose use credit card, such as VISA®, Mastercard®, American Express®, or the like, which provides credit at any location accepting such.

Upon acceptance of the instant credit offer, at Event 410, the customer 401 fills out an application or otherwise provides the requisite information to the POS associate 403. In order to ensure that the instant credit processing occurs in an expedited fashion, the information that the customer 401 is requested to provide in the application is minimal. For example, in one embodiment, the customer may be requested to submit their name, physical address, social security number and date of birth. At Event 412, once the customer has filled-out the application, the application is provided to the POS associate 403. In addition to filling out the instant credit application the customer must be able to verify their identity, thus, at Event 414, the POS associate request identification and, at Event 416, the customer provides identification, such as a driver's license or the like. The POS associate 403 is tasked with verifying that the name of the driver's license and the address match the name and address on the instant credit application.

At Event 418, the POS associate enters the provided customer application information into the POS device 405. If the POS device 405 is a non web-enabled POS device, such as traditional cash register, then the POS device may be in communication with the protocol adapter (not shown in FIG. 8) of the present invention. Thus, the protocol adapter may be executed on an in-retail location controller that is in communication with multiple POS devices. The protocol adapter serves to transform or otherwise configure the retail-specific data coming from retail-specific hardware and/or software into data that is acceptable for further processing in the instant credit process of the present invention. In this regard, the protocol adapter provides for the POS device to communicate with upstream functions, such as the enterprise server. As such, in certain embodiments, the instant credit application data undergoes protocol adapter transformation/configuration at the retail site prior to being communicated to the enterprise server. In other embodiments of the invention, if the POS device 405 is a web-enabled device, such as a smart cash register, then the POS device may be equipped with a protocol adapter or in communication with the instant credit web application (not shown in FIG. 8) to provide access to the enterprise server 407.

At Event 420, the instant credit application data is communicated to the enterprise server 407 via either the protocol adapter or the instant web credit application. The enterprise server 407 may be located at a central Information Technology (IT) hub or headquarters, external from the retail location. In certain embodiments, in addition to being in network communication with the credit-issuing entity, the enterprise server includes a reconciliation function in the event that the real-time processing of the credit application fails and subsequent processing is required. At Event 422, the enterprise server 407 communicates the instant credit application information to the credit issuing entity, such as a financial institution or the like for processing the credit application and making the determination as to whether the consumer 401 can be offered instant credit. In the illustrated embodiment of FIG. 8, the instant credit application information is communicated from the enterprise server 407 to a credit-issuing entity server 409.

It should be noted that while the credit-issuing entity is making the credit determination, other functions may be carried out by the POS associate 403 in relation to checking-out the customer. Thus, at Event 424, the POS associate may check-out additional items that the customer 410 may be purchasing by scanning UPC barcodes associated with the products, entering UPC codes/number or, in instances in which UPC codes are not applicable, entering a corresponding price for the product/service in the POS device 405. At Event 426, once all of the items have been checked-out, the POS device renders a total purchase amount, which the POS associate communicates to the customer. At optional Event 428, the POS associate may request a decision status on the customer's instant credit application. In other embodiments, the POS associate may not be required to request a decision status, while in other embodiments the credit decision may be returned prior to completing the check-out process, thus obviating the need to request a decision status.

At Event 430, based on acceptance of the customer's instant credit application, the credit-issuing entity communicates the credit line, credit pricing, credit disclosure information and/or credit card information to the enterprise server. It should be noted that the decision process is, in most embodiments, afforded a finite period of time for successful completion. In most embodiments, the retailer is able to configure the allotted time out period for completing the credit decision process. For example, the retailer may configure the time out period to be 15 or 30 seconds. Timeliness of the decision process is essential to make sure that the customer applying for the instant credit is not delayed by the process and to ensure that other customers awaiting check-out are not further delayed by the instant credit process. If the process times out or if another processing error occurs, the customer may be asked to provide an alternative payment means. It should be noted the occurrence of the timeout does not prohibit the credit determination process from proceeding. According to the reconciliation function associated with the enterprise server 407, the process continues and, if the customer is subsequently approved after the timeout or occurrence of another error, the customer may be notified of the acceptance via an alternate means, such as via mail or the like, and in certain instances, the credit card may be mailed to the consumer along with the notification of acceptance. At Event 432, the enterprise server communicates the credit line, credit pricing, credit disclosure information and/or credit card information to the POS device 405.

At Event 434, the POS device 405 communicates the disclosure information and acceptance instruction information to the POS associate 403 and, at Event 436, the disclosure information and acceptance information are communicated to the customer 401. In certain embodiments, this will provide for the POS associate to print out the disclosure information, acceptance instructions and account confirmation information. In one embodiment of the invention, the POS associate may have pre-printed credit card agreement information that is conveyed to the customer. In other embodiments, the disclosure information and acceptance information may include a bar code or other indicator which would allow the system to ‘know” which version of the card agreement is being offered to the consumer. The POS associate may also be charged with providing an indication, such as checking an appropriate checkbox or the like, that indicates that the card agreement has been given to the customer. If the indication is not provided, then the newly issued credit can not be used for the current purchase.

At Event 438, if the customer 401 chooses to accept the terms of the agreement, the customer may sign the agreement and return the agreement to the POS associate 403. At Event 440, if the customer chooses to use the instant credit for the current purchase, the POS associate enters the new credit card number into the POS device 405 to initiate the credit transaction. At Event 442, the POS device communicates with an authorization entity 411 and at Event 444, based on successful authorization, returns an authorization code to the POS device.

At Event 446, the credit transaction receipt is printed and, at Event 448, the instant credit account confirmation is printed by the POS device 401. At Events, 450 and 452, the POS associate 403 procures the credit transaction receipt and the credit account confirmation from the POS device and, at Events 454 and 456; the credit transaction receipt and the credit account confirmation are provided to the customer 401. It should be noted that if the customer accepts the instant credit but chooses not to use the instant credit for the current purchase, the account confirmation is printed and provided to the customer. The card information provided to the customer needs to be Payment Card Industry (PCI) compliant, as such, in some instances, the full account number may be provided while in other instances a reference number may be provided.

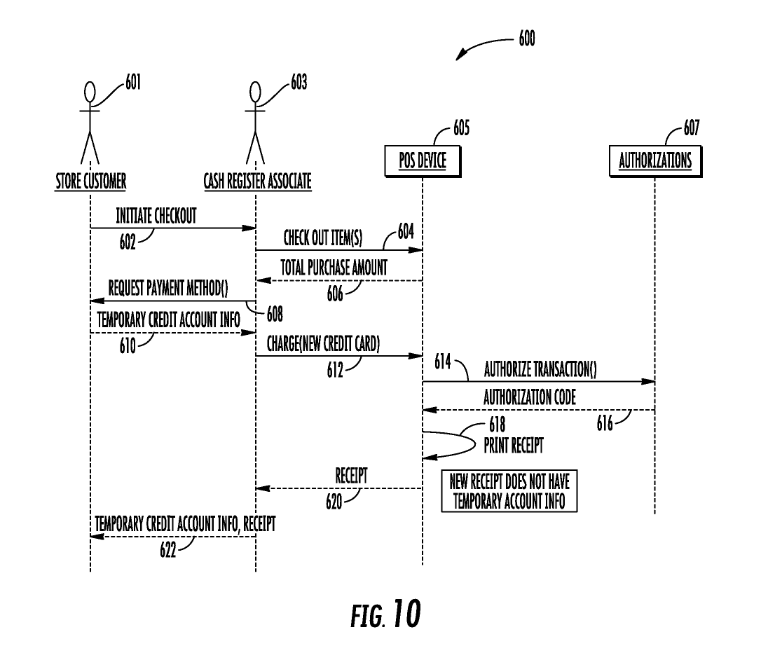

Turning the reader's attention to FIG. 9, another sequence diagram is provided for active flow instant credit processing 500 at a manned point-of-contact, such as a kiosk, in accordance with an embodiment of the present invention. At Event 502, the customer 501 initiates contact with the kiosk associate 503, such as asking the kiosk associate for assistance. It should be noted that in certain embodiments the need for a kiosk associate may be obviated by the implementation of a self-service kiosk, otherwise referred to as an unmanned kiosk, which allows for the customer to interact with absent an associate.

At Event 504, the customer 501 is offered to apply for instant credit. In the illustrated embodiment of FIG. 9, the offer is a verbal offer provided by the kiosk associate 503, while in other embodiments, in which the kiosk 505 is a self-service kiosk, the offer may be a visual offer presented via a kiosk display, such as POS touch screen display or the like. At Event 506, the customer accepts the offer to apply for instant credit, i.e., a credit card.

Upon acceptance of the instant credit offer, at Event 508, the customer 501 fills out an application or otherwise provides the requisite information to the kiosk associate 503. In order to ensure that the instant credit processing occurs in an expedited fashion, the information that the customer is requested to provide in the application is minimal. For example, in one embodiment, the customer may be requested to submit their name, physical address, social security number and date of birth. At Event 510, once the customer has filled-out the application, the application is provided to the kiosk associate. In addition to filling out the instant credit application the customer must be able to verify their identity, thus, at Event 512, the kiosk associate requests identification and, at Event 514, the customer provides identification, such as a driver's license or the like. The kiosk associate is tasked with verifying that the name of the driver's license and the address match the name and address on the instant credit application.

At Event 516, the kiosk associate 503 enters the provided customer application information into the kiosk device 505. If the kiosk device 505 is a non web-enabled device, then the kiosk device may be in communication with the protocol adapter (not shown in FIG. 9) of the present invention. Thus, the protocol adapter may be executed on an in-retail location controller that is in communication with multiple kiosk devices. The protocol adapter serves to transform or otherwise configure the retail-specific data coming from retail-specific hardware and/or software into data that is acceptable for further processing in the instant credit process of the present invention. In this regard, the protocol adapter provides for the kiosk device to communicate with upstream functions, such as the enterprise server. As such, in certain embodiments, the instant credit application data undergoes protocol adapter transformation/configuration at the retail site prior to being communicated to the enterprise server. In other embodiments of the invention, if the kiosk device 505 is a web-enabled device, then the kiosk device may be equipped with a protocol adapter or in communication with the instant credit web application (not shown in FIG. 9) to provide access to the enterprise server 407.

At Event 518, the instant credit application data is communicated to the enterprise server 507. The enterprise server may be located at a central Information Technology (IT) hub or headquarters, external from the retail location. In certain embodiments, in addition to being in network communication with the credit-issuing entity, the enterprise server includes a reconciliation function in the event that the real-time processing of the credit application fails and subsequent processing is required. At Event 520, the enterprise server 507 communicates the instant credit application information to the credit-issuing entity, such as a financial institution or the like for processing the credit application and making the determination as to whether the consumer can be offered instant credit. In the illustrated embodiment of FIG. 9, the instant credit application information is communicated from the enterprise server 507 to a credit-issuing entity server 509.

At Event 522, based on acceptance of the customer's instant credit application, the credit-issuing entity server 509 communicates the credit line, credit pricing, credit disclosure information and/or credit card information to the enterprise server 507. It should be noted that unlike the POS device scenario, active instant credit processing at the point-of-contact/kiosk is not as time dependent. Therefore, if an error should occur during processing or if a decision is not returned with a predefined time period, the kiosk associate 503 may repeat the application process, i.e., submit another instant credit application call to the credit-issuing entity in the event of a processing error or exceedingly lengthy determination process. In addition, the credit-issuing enmity guarantees that duplicate submissions of a credit request do not generate duplicate credit applications. At Event 524, the enterprise server 507 communicates the credit line, credit pricing, credit disclosure information and/or credit card information to the kiosk device 505.

At optional Event 526, the kiosk associate 503 may request a decision status on the customer's instant credit application. In other embodiments, the kiosk associate may not be required to request a decision status, if the decision status is configured to be returned automatically by the enterprise server.

At Event 528, based on the request for decision status or otherwise, the kiosk device 505 communicates the disclosure information and acceptance instruction information to the kiosk associate 503 and, at Event 530, the disclosure information and acceptance information are communicated to the customer 501. In certain embodiments, this will provide for the kiosk associate to print out the disclosure information, acceptance instructions and account confirmation information. In one embodiment of the invention, the kiosk associate may have pre-printed credit card agreement information that is conveyed to the customer. In other embodiments, the disclosure information and acceptance information may include a bar code or other indicator which would allow the system to ‘know” which version of the card agreement is being offered to the consumer. The kiosk associate may also be charged with providing an indication, such as checking an appropriate checkbox or the like, that indicates that the card agreement has been given to the customer. If the indication is not provided, then the newly issued credit can not be used for the current purchase.

At Event 530, once the customer 501 has agreed to the credit disclosure terms, the kiosk associate 503 requests printing of the account confirmation and, at Event 532, the instant credit account confirmation is printed by the kiosk device 505. At Event 534 the kiosk associate procures the credit account confirmation from the kiosk device and, at Event 536, the credit account confirmation is provided to the customer.

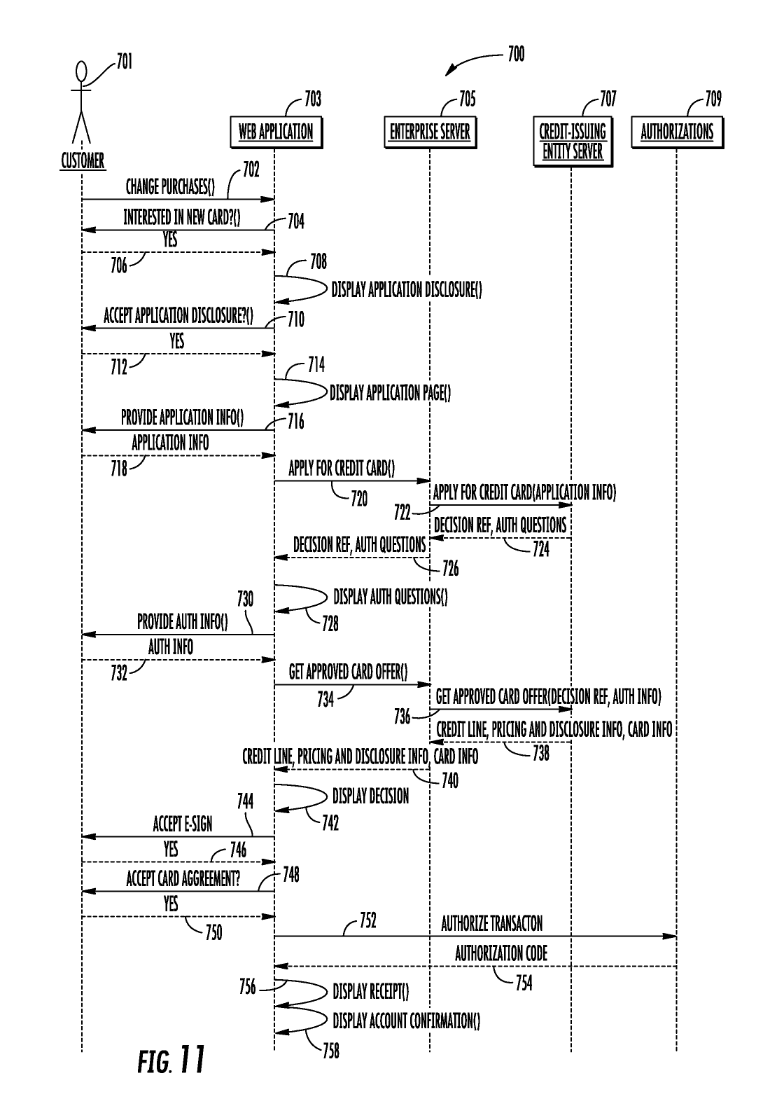

Referring to FIG. 10, a sequence drawing is shown of a credit purchase 600 made by a customer 601 returning to a retail location to make purchases or additional purchases after instant credit has been accepted but before the customer has received the actual credit card, in accordance with an embodiment of the present invention. At Event 602, the customer 601 initiates product or service checkout with a point-of-sale (POS) associate 603 otherwise referred to as a cash register associate. It should be noted that in certain embodiments the need for a cash register associate may be obviated by the implementation of a self-service point-of-sale (POS), otherwise referred to as a self-service cash register. In such embodiments in which the customer chooses to check-out via a self service (POS), a retail associate may be called upon if the customer chooses to use previously approved instant credit.

At Event 604, the checkout process is initiated by the POS associate 603 interfacing with the POS device 605, such as a cash register or the like. The POS associate may scan UPC barcodes associated with the products, enter UPC codes/number or, in instances in which UPC codes are not applicable, enter a corresponding price for product/service. At Event 606, once all of the items have been checked-out, the POS device renders a total purchase amount, which the POS associate communicates to the customer 601. At Event 608, the POS associate requests a payment method from the customer and, at Event 610, the customer provides their temporary credit account information to the POS associate.

At Event 612, the POS associate 603 enters the temporary credit card number into the POS device 605 to initiate the credit transaction. At Event 614, the POS device communicates with an authorization entity 607 and at Event 616, based on successful authorization, returns an authorization code to the POS device.

At Event 618, the credit transaction receipt is printed. It is noted that the receipt that is printed, unlike the receipt in the initial transaction conducted at the time that the instant credit was applied for and accepted by the customer, does not include the temporary account number. At Event 620, the POS associate 603 procures the credit transaction receipt and, at Event 622, the credit transaction receipt is provided to the customer 601.

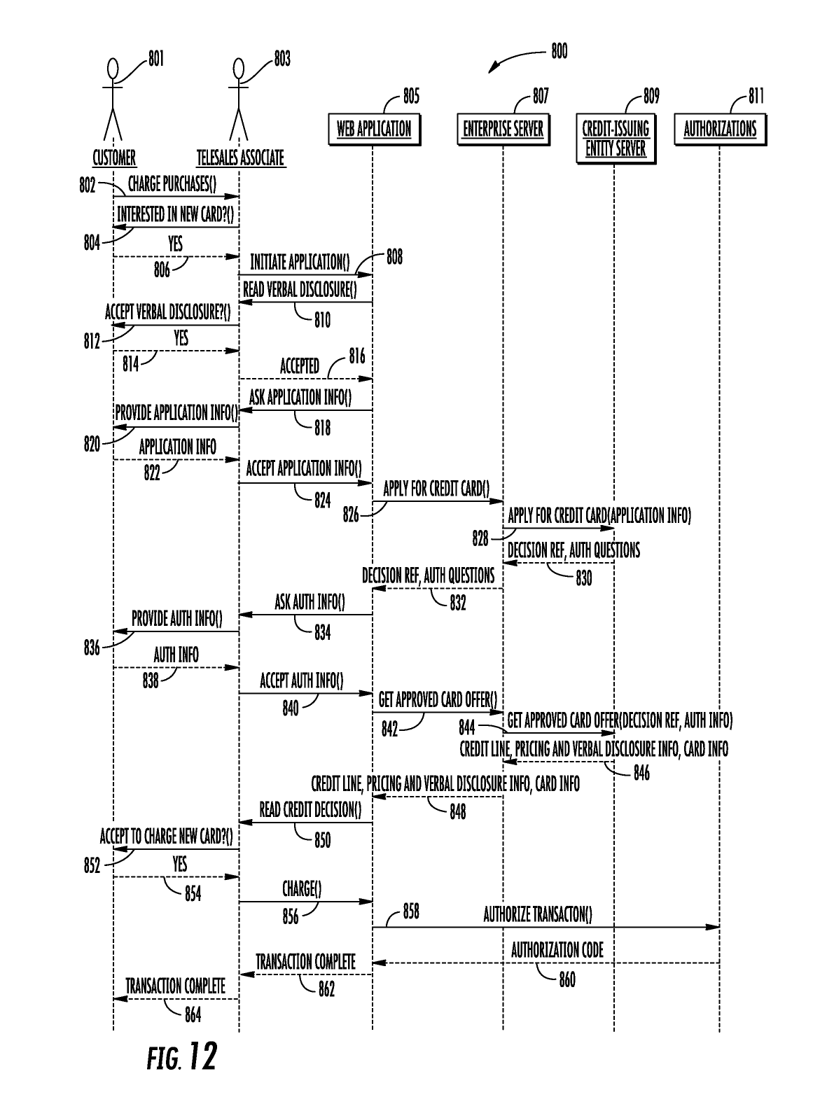

Now turning to FIG. 11, another sequence diagram is provided for active flow instant credit processing 700 at a partner website, in accordance with an embodiment of the present invention. The sequences presented in FIG. 11 are analogous to the sequences that would be provided at an unmanned or self-service kiosk, except that checkout functionality is typically not provided for at the kiosk.

At Event 702, after the customer 701 has chosen desired products at a customer website/web application, the customer initiates product checkout, which typically requires a credit or debit card number or the like.

At Event 704, the web application 703 queries the customer 701 as to whether the customer is interested in applying for instant credit. The query may be part of the checkout process or the customer may be redirected to another webpage.

At Event 706, the customer 701 accepts the offer to apply for instant credit, i.e., a credit card. It should be noted that the credit card being offered may be a private label card, which is limited to credit with this particular retailer or the credit card being offered may be a general purpose use credit card, such as American Express®, VISA® or Mastercard®, which provides credit at any location accepting such.

Upon acceptance of the instant credit offer, at Event 708, the web application 703 displays the instant credit application disclosure information and, at Event 710, asks the customer 701 to read and accept the terms disclosed in the instant credit application disclosure information. At Event 712, the customer responds, typically by checking an appropriate check box, to accept the application disclosure.

At Event 714, the web application 703 displays the instant credit application web page and, at Event 716, asks that the customer 701 provide the requisite application information. For example, in one embodiment, the customer may be requested to submit their name, physical address, social security number and date of birth. At Event 718, the customer provides the requisite application information and communicates the information to the web application 703.

At Event 720, the instant credit application data is communicated from the web application 703 to the enterprise server 705. The enterprise server may be located at a central Information Technology (IT) hub or headquarters. In accordance with certain embodiments, in addition to being in network communication with the credit-issuing entity, the enterprise server 705 includes a reconciliation function in the event that the real-time processing of the credit application fails and subsequent processing is required. At Event 722, the enterprise server communicates the instant credit application information to the credit-issuing entity, such as a financial institution or the like for processing the credit application and making the determination as to whether the consumer can be offered instant credit. In the illustrated embodiment of FIG. 11, the instant credit application information is communicated from the enterprise server 705 to a credit-issuing entity server 707.

At Event 724, once the credit-issuing entity has approved the customer 701, the credit-issuing entity server 707 returns to the enterprise server 705 a series of authentication questions, commonly referred to as out-of-wallet questions. The authentication questions are questions that only the customer should have the answers to and serve to verify the identity of the customer. The out-of-wallet questions are typically generated by a third party, such as a credit reporting bureau that has access to personal information pertaining to the individual. In turn, at Event 726, the enterprise server communicates the approval and the authentication questions to the web application 703.

At Event 728, the web application 703 displays the authentication questions to the customer 701 and, at Event 730, queries the customer 701 to provide answers to the authentication questions. At Event 732, the customer 701 provides requisite answers to the authentication questions and communicates the authentication information to the web application. At Event 734, the web application communicates the authentication information to the enterprise server 705 and, at Event 736; the enterprise server communicates the authentication information (i.e., answers to the authentication questions) to the credit-issuing entity server 707.

At Event 738, based on verification of correct answers submitted to the authentication questions, the credit-issuing entity server 707 communicates the credit line, credit pricing, credit disclosure information and/or credit card information to the enterprise server 705. At Event 740, the enterprise server communicates the credit line, credit pricing, credit disclosure information and/or credit card information to the web application 703 and, at Event 742, the web application displays the credit line, credit pricing, credit disclosure information and/or credit card information.

At Event 744, the web application 703 queries the customer 701 to provide an electronic signature and, at Event 746, the customer provides and communicates the electronic signature to the web application 703. At Event 748, the web application queries the customer to accept the card agreement and, at Event 750, the customer enters and communicates to the web application the requisite acceptance of the card agreement.

At Event 752, the web application 703 communicates with an authorization entity 709 to authorize payment of the pending purchase with the newly issued credit and, at Event 754, based on successful authorization, returns an authorization code to the web application. At Event 756, the web application displays a credit transaction receipt and at Event 758 the web application displays the instant credit account confirmation, which may include an account number for making further purchases either at the retail location or at the website prior to receiving the physical credit card in the mail.

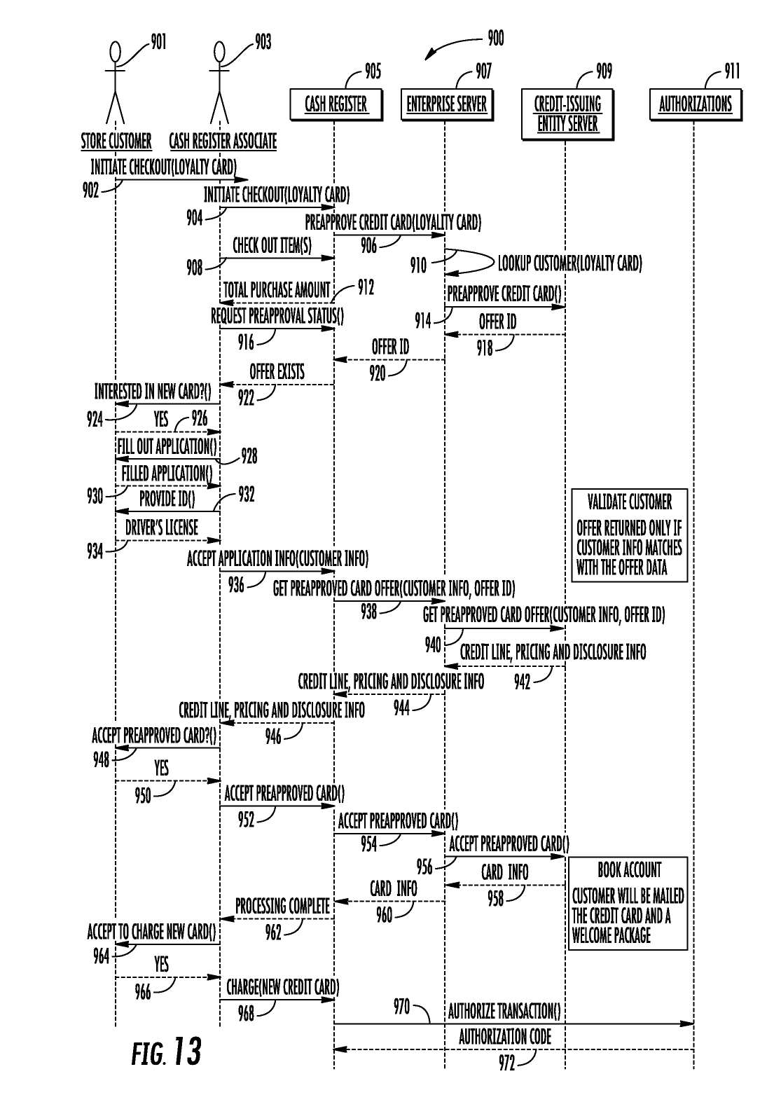

Referring to FIG. 12, a sequence diagram is depicted for active flow instant processing 800 via a partner call center, in accordance with an embodiment of the present invention. At Event 802, after the customer 801 has established communication with a partner call center and chosen desired products, the customer initiates the purchase process, which typically requires a credit or debit card number or the like.

At Event 804, the telesales associate 803 asks the customer as to whether the customer 801 is interested in applying for instant credit. At Event 806, the customer accepts the offer to apply for instant credit, i.e., a credit card.

Upon acceptance of the instant credit offer, at Event 808, the telesales associate 803 communicates with a web application 805 to initiate the instant credit application and, at Event 810, the web application 805 returns an instant credit disclosure to the telesales associate. At Event 812, the telesales associate reads the disclosure to the customer and asks the customer to accept the terms disclosed in the instant credit application disclosure information. At Event 814, the customer verbally responds to accept the application disclosure and, at Event 816, the telesales associate indicates the customer acceptance in the telemarketing application.

At Event 818, the web application 805 displays the instant credit application to the telesales associate 803 and, at Event 820, the telesales associate provides the customer 801 with the instant credit application questions, such as, but not limited to, the customers full name, physical address, social security number and date of birth. At Event 822, the customer provides the answers to the requisite application information questions and, at Event 824, the telesales associate enters the answers in the telemarketing application.

At Event 826, the instant credit application data is communicated to the enterprise server 807 and at Event 828, the enterprise server communicates the instant credit application information to the credit-issuing entity server 809, for processing the credit application and making the determination as to whether the consumer 801 can be offered instant credit.

At Event 830, once the credit-issuing entity server 809 has approved the customer, the credit-issuing entity server returns to the enterprise server 807 a series of authentication questions, commonly referred to as out-of-wallet questions. In turn, at Event 832, the enterprise server communicates the approval and the authentication questions to the telemarketing application.

At Event 834, the web application 805 displays the authentication questions to the telesales associate 803 and, at Event 836, the telesales associate verbally conveys the authentication questions to the customer 801. At Event 838, the customer communicates requisite answers to the authentication questions to the telesales associate. At Event 840, the telesales associate enters the authentication answers in the telemarketing application. At Event 842, the web application communicates the authentication question answers to the enterprise server 807 and, at Event 844; the enterprise server communicates the authentication information (i.e., answers to the authentication questions) to the credit-issuing entity server 809.

At Event 846, based on verification of correct answers submitted to the authentication questions, the credit-issuing entity server 809 communicates the credit line, credit pricing, credit disclosure information and/or credit card information to the enterprise server 807. At Event 848, the enterprise server communicates the credit line, credit pricing, credit disclosure information and/or credit card information to the web application 805 and, at Event 850, the web application displays the credit line, credit pricing, credit disclosure information and/or credit card information to the telesales associate 803. At Event 852, the telesales associate verbally conveys the credit line, credit pricing, credit disclosure information and/or credit card information to the customer 801.

At Event 854, if the customer 801 chooses to accept the terms of the credit agreement, the customer verbally communicates acceptance to the telesales associate 803. At Event 856, if the customer chooses to use the instant credit for the current purchase, the telesales associate enters the new credit card number into the web application 805 to initiate the credit transaction. At Event 858, the web application communicates with an authorization entity 811 and at Event 860, based on successful authorization, returns an authorization code to the web application 805.

At Event 862, the web application 805 displays a transaction complete display to the telesales associate 803 and, at Event 864, the telesales associate verbally conveys to the customer 801 that the transaction is complete.

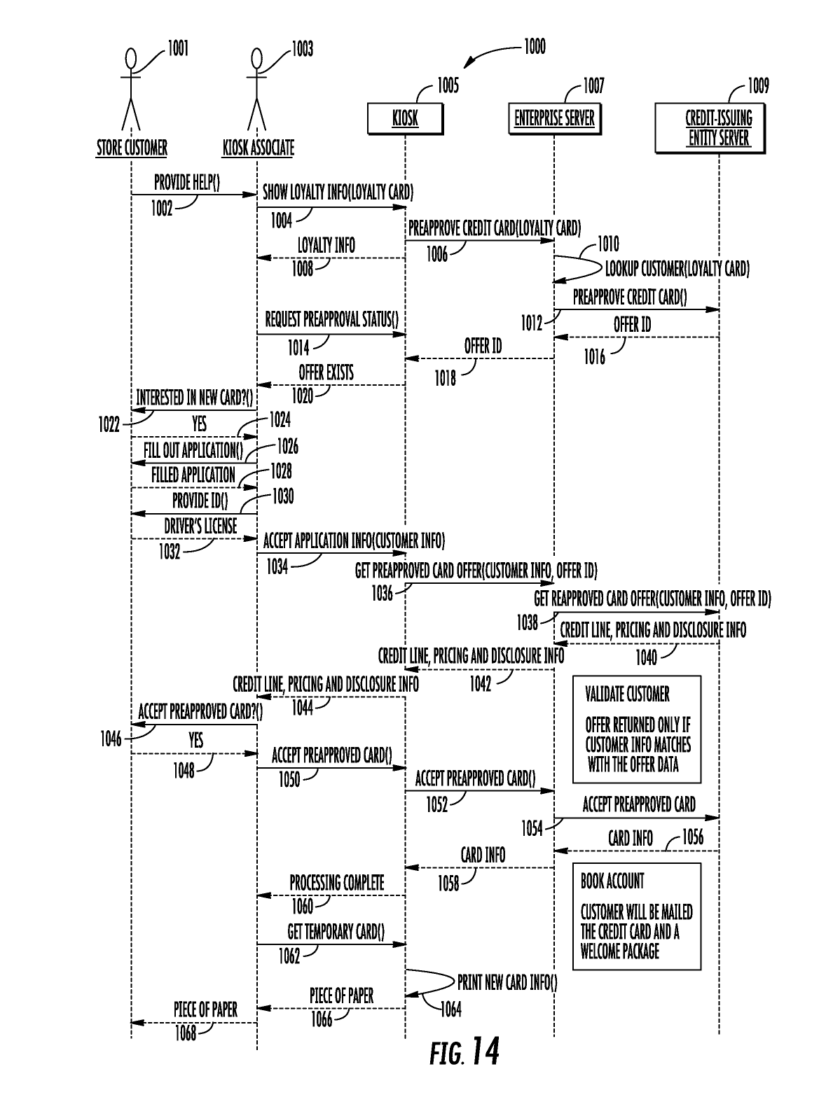

Referring to FIG. 13, a sequence diagram is depicted for passive flow instant credit processing 900 at a retail location POS, such as a cash register, in accordance with an embodiment of the present invention. At Event 902, the customer 901 initiates product or service checkout with a point-of-sale (POS) associate 903 otherwise referred to as a cash register associate. In order to provide the customer with passive instant credit (i.e., when the customer is pre-qualified for credit absent their knowledge) the customer may be a previous customer of the retailer, such as customer previously enrolled in a customer loyalty program or the like or have previous relationship or experience with the credit-issuing entity. Thus, in addition to providing the POS associate with the items to be purchases, the customer may further provide the POS associate with their customer loyalty card.

At Event 904, the checkout process is initiated by the POS associate 903 interfacing with the POS 905 device, such as cash register or the like and the sales associate enters the customer's loyalty card number in the POS device. At Event 906, the POS device sends a query to the enterprise server 907 to determine if the customer is pre-approved for instant credit and, at Event 910, the enterprise server looks-up the customer based on the customer's loyalty card number. At Event 914, the enterprise server communicates with the credit-issuing entity, such as a credit-issuing entity server 909, to determine if the customer is pre-approved for credit and the offer that can be extended to the customer.

At Event 918, the credit-issuing entity server 909 communicates an offer identifier (ID) to the enterprise server 907 and, in turn, at Event 920, the enterprise server communicates the offer ID to the POS device 905. At Event 922, the POS device conveys to the POS associate 903 that a pre-approved offer exists and, at Event 924, the customer 901 is asked by the POS associate if they are interested in applying for/obtaining pre-approved instant credit.

It should be noted that while the pre-approval is being determined for the customer 901, other functions may be carried out by the POS associate 903 in relation to checking-out the customer. Thus, at Event 908, the POS associate may check-out additional items that the customer may be purchasing and, at Event 912, once all of the items have been checked-out, the POS device renders a total purchase amount, which the POS associate communicates to the customer. At optional Event 916, the POS associate may request preapproval status. In other embodiments, the POS associate may not be required to request preapproval status, while in other embodiments the preapproval decision may be returned prior to completing the check-out process, thus obviating the need to request preapproval status.

At Event 926, the customer 901 accepts the offer to apply for pre-approved instant credit, i.e., a credit card. Upon acceptance of the pre-approved instant credit offer, at optional Event 928, the customer may be asked by the POS associate 903 to fill out an application and, at optional Event 930, the customer may fill out and submit an application or otherwise provides the requisite information to the POS associate. At Event 932, once the customer has filled-out the application, the POS associate requests identification and, at Event 934, the customer provides identification, such as a driver's license or the like. The POS associate is tasked with verifying that the name of the driver's license and the address match the name and address on the instant credit application.

At Event 936, the POS associate 903 enters the customer's acceptance of the pre-approved credit and optionally the customer application information into the POS device 905. At Event 938, the customer's acceptance and any optional instant credit application data is communicated to the enterprise server 907. At Event 940, the enterprise server communicates the customer acceptance and any optional instant credit application information to the credit-issuing entity server 909 for processing the credit application. The offer is returned to the customer 901 only if the customer information, in the acceptance or the optional application information, matches with the pre-approved offer data.

At Event 942, based on a match between the customer information and the pre-approved offer data, the credit-issuing entity server 909 communicates the credit line, credit pricing, credit disclosure information and/or credit card information to the enterprise server 907. At Event 944, the enterprise server 907 communicates the credit line, credit pricing, credit disclosure information and/or credit card information to the POS device 905.

At Event 946, the POS device 905 communicates the disclosure information and acceptance instruction information to the POS associate 903 and, at

Event 948, the disclosure information and acceptance information are communicated to the customer 903.

At Event 950, if the customer 903 chooses to accept the terms of the agreement, the customer may sign the agreement and return the agreement to the POS associate 903. At Event 952, the POS associate communicates to the POS device 905 the customer's acceptance of the pre-approved credit. In turn, at Event 954, the POS device communicates the acceptance of the pre-approved credit to the enterprise server 907 and, at Event 956; the enterprise server communicates the customer's acceptance of the pre-approved credit to the credit-issuing entity, such as a credit-issuing entity server 909 or the like.

At Event 958, once the card-issuing entity has booked the account, the credit card information is communicated from the card issuing entity server 909 to the enterprise server 907 and, at Event 960, the card information is communicated from the enterprise server to the POS device 905. At Event 962, the POS device conveys to the POS associate 903 that processing is complete and, at Event 964, the POS associate asks the customer 901 if they desire to charge the current purchase to the new credit card account.

If the customer 901 chooses to use the instant credit for the current purchase, at Event 968, the POS associate 903 enters the new credit card number into the POS device 905 to initiate the credit transaction. At Event 970, the POS device communicates with an authorization entity 911 and at Event 972, based on successful authorization, returns an authorization code to the POS device 905. Subsequently, the credit transaction receipt is printed and the instant credit account confirmation is printed by the POS device and communicated to the customer.

Moreover, referring to FIG. 14, a sequence diagram is depicted for passive flow instant credit processing 1000 at a retail location point-of-contact, such as a manned kiosk, in accordance with an embodiment of the present invention. At Event 1002, the customer 1001 initiates contact with the kiosk associate 1003, such as asking the kiosk associate for assistance with a product or the like. In order to provide the customer with passive instant credit (i.e., when the customer is pre-qualified for credit absent their knowledge) the customer may be a previous customer of the retailer, such as customer previously enrolled in a customer loyalty program or the like or had a previous direct or indirect relationship or encounter with the credit-issuing entity. Thus, in addition to asking the kiosk associate for assistance, the customer may further provide the kiosk associate with their customer loyalty card.

At Event 1004, the kiosk associate 1003 enters the customer's loyalty card number in the kiosk device 1005. At Event 1006, the kiosk device sends a query to the enterprise server 1007 to determine if the customer is pre-approved for instant credit and, at Event 1010, the enterprise server looks-up the customer based on the customer's loyalty card number. At Event 1012, the enterprise server 1007 communicates with the credit-issuing entity, such as a credit-issuing entity server 1009, to determine if the customer is pre-approved for credit and the offer that can be extended to the customer.

At Event 1016, the credit-issuing entity server 1009 communicates an offer identifier (ID) to the enterprise server 1007 and, in turn, at Event 1018, the enterprise server communicates the offer ID to the kiosk device 1005. At Event 1020, the kiosk device conveys to the kiosk associate 1003 that a pre-approved offer exists and, at Event 1022, the customer 1001 is asked by the POS associate if they are interested in applying for pre-approved instant credit.

At optional Event 1014, the kiosk associate 1003 may request preapproval status. In other embodiments, the kiosk associate may not be required to request preapproval status, while in other embodiments the preapproval decision may be returned prior to requesting preapproval status.

At Event 1024, the customer 1001 accepts the offer to apply for pre-approved instant credit, i.e., a credit card. Upon acceptance of the pre-approved instant credit offer, at optional Event 1026, the customer may be asked by the kiosk associate 1003 to fill out an application and, at optional Event 1028, the customer may fill out and submit an application or otherwise provides the requisite information to the kiosk associate. At Event 1030, once the customer has filled-out the application, the kiosk associate requests identification and, at Event 1032, the customer provides identification, such as a driver's license or the like. The kiosk associate is tasked with verifying that the name of the driver's license and the address match the name and address on the instant credit application.

At Event 1034, the kiosk associate 1003 enters the customer's acceptance of the pre-approved credit and optional customer application information into the kiosk device 1005. At Event 1036, the customer's acceptance and any optional instant credit application data is communicated to the enterprise server 1007. At Event 1038, the enterprise server communicates the customer acceptance and any optional instant credit application information to the credit-issuing entity server 1009 for processing the credit application. The offer is returned to the customer 1001 only if the customer information, in the acceptance or the optional application information, matches with the pre-approved offer data.

At Event 1040, based on a match between the customer information and the pre-approved offer data, the credit-issuing entity server 1009 communicates the credit line, credit pricing, credit disclosure information and/or credit card information to the enterprise server 1007. At Event 1042, the enterprise server communicates the credit line, credit pricing, credit disclosure information and/or credit card information to the kiosk device 1005.

At Event 1044, the kiosk device 1005 communicates the disclosure information and acceptance instruction information to the kiosk associate 1003 and, at Event 1046, the disclosure information and acceptance information are communicated to the customer 1001.

At Event 1048, if the customer 1001 chooses to accept the terms of the agreement, the customer may sign the agreement and return the agreement to the kiosk associate. At Event 1050, the kiosk associate 1003 communicates to the kiosk device 1005 the customer's acceptance of the pre-approved credit. In turn, at Event 1052, the kiosk device communicates the acceptance of the pre-approved credit to the enterprise server 1007 and, at Event 1054; the enterprise server communicates the customer's acceptance of the pre-approved credit to the credit-issuing entity, such as a credit-issuing entity server 1009 or the like.

At Event 1056, once the card-issuing entity has booked the account, the credit card information is communicated from the card issuing entity server 1009 to the enterprise server 1007 and, at Event 1058, the card information is communicated from the enterprise server to the kiosk device 1005. At Event 1060, the kiosk device conveys to the kiosk associate 1003 that processing is complete and, at Event 1062, the kiosk associate requests a temporary card from the kiosk device. In turn, at Event 1064, the kiosk device prints a temporary card and, at Event 1066, the temporary card is procured by the kiosk associate and, at Event 1068, the kiosk associate conveys the temporary card to the customer 1001.

Thus, present embodiments provide for a comprehensive instant financial credit system that allows for a retail credit partner to offer and process instant credit requests at any Point-Of-Sale (POS) or Point-Of-Contact (POC). In addition, the embodiments described herein provide for an off-the-shelf instant credit system that can be implemented at any credit partner without the need for elaborate customization or configuration, as required by current point-to-point instant credit solutions and/or systems. Thus, the disclosed embodiments vastly improve the deployment time encountered by current systems which require custom software, configuration and the like. In addition, present embodiments support both “active” instant credit decisioning and “passive” instant credit decisioning. Active decisioning allows for credit decisions to be made on-the-fly based on information provided for in the instant credit request and passive decisioning provides for pre-approved credit based on information previously provided to the credit-issuing entity and/or credit partner. In addition, embodiments herein disclosed provide for safeguards in the event that instant credit decisions are currently unavailable, such as subsequent reconciliation processing and notification of credit approval.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing instant credit processing, the system comprising:
a protocol adapter in communication with one or more instant credit request first input channels, wherein the first input channels are associated with a credit partner;
an enterprise gateway in communication with the protocol adapter; and
a credit-issuing entity in communication with the enterprise gateway,
wherein the protocol adapter includes a message transformation routine configured to transform credit request messages and credit decision messages communicated from and to the first input channels to provide for upstream and downstream communication within the instant credit decisioning system,
wherein the enterprise gateway is configured to provide an interface between the protocol adapter and the credit-issuing entity, and
wherein the credit-issuing entity is configured to provide a plurality of interfacing services related to an instant credit request, including communicating a decision for the instant customer credit request.

2. The system of claim 1, further comprising an instant credit web application in communication with one or more instant credit request second input channels and the enterprise gateway, wherein the second input channels are web-enabled input channels associated with the credit partner.

3. The system of claim 2, wherein the instant credit web application is further defined as a credit partner-configurable application configured to provide the credit partner customization based on one or more device types of the second input channels.

4. The system of claim 1, wherein the one or more instant credit request first input channels include one or more of a non-web-enabled point-of-sale, a web-enabled point-of-sale, a self-service point-of-contact, a credit partner-manned point-of-contact, a web-enabled device or a credit partner call center.

5. The system of claim 2, wherein the one or more instant credit request second input channels include one or more of a web-enabled point-of-sale, a self-service point-of-contact, a credit partner-manned point-of-contact, a credit partner call center, a web-enabled mobile device, a web-enabled wired device, or an electronic commerce web application.

6. The system of claim 1, wherein the plurality of interfacing services provided by the credit-issuing entity includes an active credit decisioning service, wherein an instant credit decision is determined based on a currently received instant credit request.

7. The system of claim 1, wherein the plurality of interfacing services provided by the credit-issuing entity includes a passive credit decisioning service, wherein the instant credit decision is credit pre-approval determined based on a previous encounter with the credit partner or the credit-issuing entity.

8. The system of claim 1, wherein the plurality of interfacing services provided by the credit-issuing entity includes other financial products decisioning service, wherein the other financial products decisioning is at least one of active other financial product decisioning or passive other financial product decisioning.

9. The system of claim 2, wherein the protocol adapter is in communication with at least one of the second input channels, and wherein the at least one second input channel is operable to be configured to communicate instant credit requests and receive instant credit decisions via either the protocol adapter or the instant credit web application.

10. The system of claim 2, wherein the instant credit web application is in communication with at least one of the first input channels, and wherein the at least one first input channel is operable to be configured to communicate instant credit requests and receive instant credit decisions via either the instant credit web application or the protocol adapter.

11. The system of claim 1, wherein the protocol adapter further comprises a store-and-forward (SAF) routine configured to process instant credit requests subsequently in the event that an upstream capability is presently unavailable.

12. The system of claim 1, wherein the enterprise gateway further comprises a store-and-forward (SAF) routine configured to process instant credit decisions subsequently in the event that a downstream capability is presently unavailable.

13. The system of claim 1, wherein the enterprise gateway further comprises a reconciliation routine configured to perform out-of-channel credit decision processing in the event that instant credit decisioning is presently unavailable.

14. A system for providing instant credit processing, the system comprising:
an instant credit web application in communication with one or more instant credit request input channels, wherein the input channels are associated with a credit partner;
an enterprise gateway in communication with the instant credit web application; and
a credit-issuing entity in communication with the enterprise gateway,
wherein the instant credit web application is configured to receive credit requests from the input channels, communicate the credit requests to the credit-issuing entity via the enterprise gateway, receive credit decisions from the credit-issuing entity via the enterprise gateway and communicate the credit decision to a respective input channel,
wherein the enterprise gateway is configured to provide an interface between the instant credit web application and the credit-issuing entity, and
wherein the credit-issuing entity is configured to provide a plurality of interfacing services related to an instant credit request, including communicating a decision for the instant customer credit request.

15. The system of claim 14, wherein the instant credit web application is further defined as a credit partner-configurable application configured to provide the credit partner customization based on one or more device types of the input channels.

16. The system of claim 14, wherein the one or more instant credit request input channels include one or more of a web-enabled point-of-sale, a self-service point-of-contact, a credit partner-manned point-of-contact, a credit partner call center, a web-enabled mobile device, a web-enabled wired device, or an electronic commerce web application.

17. The system of claim 14, wherein the plurality of interfacing services provided by the credit-issuing entity include two or more of active credit decisioning service, passive credit decisioning service, customer identification and authentication service, offers management service, product marketing data service, product agreement disclosure service and application disclosure service.

18. The system of claim 14, wherein the plurality of interfacing services provided by the credit-issuing entity includes an active credit decisioning service, wherein an instant credit decision is determined based on a currently received instant credit request.

19. The system of claim 14, wherein the plurality of interfacing services provided by the credit-issuing entity includes a passive credit decisioning service, wherein the instant credit decision is credit pre-approval determined based on a previous encounter with the credit partner or the credit-issuing entity.

20. The system of claim 14, wherein the plurality of interfacing services provided by the credit-issuing entity includes other financial products decisioning service, wherein the other financial products decisioning is at least one of active other financial product decisioning or passive other financial product decisioning.

21. The system of claim 14, wherein the enterprise gateway further comprises a reconciliation routine configured to perform out-of-channel credit decision processing in the event that instant credit decisioning is presently unavailable.

22. A system for providing instant credit processing, the system comprising:
a protocol adapter in communication with one or more instant credit request first input channels, wherein the first input channels are associated with a credit partner;
an instant credit web application in communication with one or more instant credit request second input channels, wherein the second input channels are associated with the credit partner;
an enterprise gateway in communication with the protocol adapter and the instant credit web application; and
a credit-issuing entity in communication with the enterprise gateway,
wherein the protocol adapter includes a message transformation routine configured to transform credit request messages and credit decision messages communicated from and to the first input channels to provide for upstream and downstream communication within the instant credit decisioning system,
wherein the instant credit web application is configured to receive instant credit requests from the second input channels, communicate the credit requests to the credit-issuing entity via the enterprise gateway, receive credit decisions from the credit-issuing entity via the enterprise gateway and communicate the credit decision to a respective input channel,
wherein the enterprise gateway is configured to provide an interface between the protocol adapter, the instant credit web application and the credit-issuing entity, and
wherein the credit-issuing entity is configured to provide a plurality of interfacing services related to an instant credit request, including communicating a decision for the instant customer credit request.

23. The system of claim 22, wherein the one or more instant credit request first input channels include one or more of a non-web-enabled point-of-sale, a web-enabled point-of-sale, a self-service point-of-contact, a credit partner-manned point-of-contact, a web-enabled device or a credit partner call center.

24. The system of claim 23, wherein the one or more instant credit request second input channels include one or more of the web-enabled point-of-sale, the self-service point-of-contact, the credit partner-manned point-of-contact, the credit partner call center, the web-enabled wired device, a web-enabled mobile device, or an electronic commerce web application.

25. The system of claim 22, wherein the plurality of interfacing services provided by the credit-issuing entity includes an active credit decisioning service, wherein an instant credit decision is determined based on a currently received instant credit request.

26. The system of claim 22, wherein the plurality of interfacing services provided by the credit-issuing entity includes a passive credit decisioning service, wherein the instant credit decision is credit pre-approval determined based on a previous encounter with the credit partner or the credit-issuing entity.

27. The system of claim 22, wherein the plurality of interfacing services provided by the credit-issuing entity includes other financial products decisioning service, wherein the other financial products decisioning is at least one of active other financial product decisioning or passive other financial product decisioning.

28. The system of claim 22, wherein the instant credit web application is further configured as a primary recipient of instant credit requests from web-enabled input channels and the protocol adapter is further configured as a secondary recipient of instant credit requests from the web-enabled input channels.

29. The system of claim 22, wherein the protocol adapter is further configured as a primary recipient of instant credit requests from non-web-enabled input channels.

30. A protocol adapter apparatus configured to process instant credit requests, the apparatus comprising:
a first transceiver configured to receive instant credit request messages from one or more point-of-sale (POS) devices and transmit instant credit decision messages;
a protocol transformer configured to transform one or more of the instant credit requests messages from a POS device format to a predetermined instant credit format and transform corresponding instant credit decision messages from the predetermined instant credit format to the POS device format; and
a second transceiver configured to transmit transformed instant credit request messages to a credit-issuing entity and receive instant credit decision messages in the predetermined format from the credit-issuing entity.

31. The apparatus of claim 30, wherein the protocol transformer is further configured to transform the instant credit requests from a POS device to Extensible Markup Language (XML) format.

32. The apparatus of claim 30, wherein the first transceiver further comprises a persistent network listener configured to continuously listen to the one or more POS devices.

33. The apparatus of claim 30, wherein the first transceiver is further configured to receive instant credit requests from one or more of a point-of-contact (POC), a credit partner call center or a web-enabled device.

34. The apparatus of claim 30, wherein the second transceiver further comprises a Transmission Control Protocol (TCP) socket.

35. The apparatus of claim 30, wherein the second transceiver is further configured to transmit and receive using Secure Socket Layer (SSL) protocol and Java Message Service (JMS) protocol.

36. The apparatus of claim 30, further comprising a Store-And-Forward (SAF) queue configured to queue instant credit requests in the event of a time-out.

37. The apparatus of claim 30, further comprising a heartbeat monitor configured to ensure a channel is maintained between the protocol adapter and a credit-issuing entity gateway apparatus.

38. A computer program product comprising:
a computer-readable medium comprising:
a first set of codes for causing a computer to receive first instant credit request messages from Point-Of-Sale (POS) devices;
a second set of codes for causing a computer to transform the first instant credit request messages from a POS device type-specific format to a predetermined network-compatible format; and
a third set of codes for causing a computer to transmit the transformed first instant credit request messages to a credit-issuing entity.

39. The computer program product of claim 38, wherein the first set of codes is further operable to cause the computer to receive instant credit messages from non-web-enabled POS devices.

40. The computer program product of claim 38, wherein the first set of codes is further operable to cause the computer to receive second instant credit messages from Point-Of-Contact (POC) devices.

41. The computer program product of claim 40, wherein the first set of codes is further operable to cause the computer to receive instant credit messages from non-web-enabled POC devices.

42. The computer program product of claim 40, wherein the second set of codes is further operable to cause the computer to transform the second instant credit messages from a POC device type-specific format to the predetermined network-compatible format.

43. The computer program product of claim 38, wherein the first set of codes is further operable to cause the computer to receive second instant credit messages from a credit partner call center.

44. The computer program product of claim 43, wherein the second set of codes is further operable to cause the computer to transform the second instant credit messages from a call center device type-specific format to the predetermined network-compatible format.

45. The computer program product of claim 38, further comprising a fourth set of codes for causing the computer to receive instant credit decision messages from the credit-issuing entity, a fifth set of codes for causing a computer to transform the instant credit decision messages from the predetermined network format to the POS device-type specific format, and a sixth set of codes for causing a computer to transmit the transformed instant credit decision messages to a POS device associated with the corresponding instant credit request message.

46. The computer program product of claim 38, further comprising a fourth set of codes for causing a computer to store the transformed first instant credit request messages in a queue based on an occurrence of a time-out.

47. The computer program product of claim 38, further comprising a fourth set of codes for causing a computer to monitor activeness of a connection to a gateway device.

48. The computer program product of claim 47, further comprising a fifth set of codes for causing a computer to generate an alert message in the event that the connection to the gateway device is determined to be inactive.
